(19) United States
(12) Patent Application Publication
(10) Pub. No.: US 2024/0106008 A1
(43) Pub. Date: Mar. 28, 2024

(54) Energy Apparatus

(71) Applicant: TECHNISCHE UNIVERSITEIT DELFT, Delft (NL)

(72) Inventors: Fokko Marten Mulder, Delft (NL); Audrey Iranzo, Delft (NL)

(21) Appl. No.: 18/266,837

(22) PCT Filed: Dec. 16, 2021
(86) PCT No.: PCT/NL2021/050771

§ 371 Date: Jun. 13, 2023

(30) Foreign Application Priority Data
Dec. 16, 2020 (NL) 2027120
Feb. 19, 2021 (NL) 2027596

(51) Int. Cl. H01M 10/30; H01M 4/24; H01M 10/44; H01M 50/489; H01M 50/514; H01M 50/618

(52) U.S. Cl. CPC H01M 10/30; H01M 4/24; H01M 10/44; H01M 50/489; H01M 50/514; H01M 50/618; H01M 2300/0014

(57) ABSTRACT

An energy apparatus comprising at least one functional unit including a first cell comprising a first cell electrode and at least one first cell opening for a first cell aqueous liquid and for a first cell gas. The first cell electrode comprises an iron-based electrode; a second cell comprising a second cell electrode and at least one second cell opening for a second cell aqueous liquid and for a second cell gas. The second cell electrode comprises at least one metal comprising 60-99.9 at. % nickel, and 0.1-35 at. % iron and a separator. The first cell and the second cell share the separator which is configured to block transport of at least one of O2 and H2 from one cell to another while having permeability for at least one of hydroxide ions (OH−) monovalent sodium (Na+), monovalent lithium (Li+) and monovalent potassium (K+).

### FIELD OF THE INVENTION

The invention relates to an energy apparatus. The invention further relates to an energy system. The invention further relates to a method. The invention further relates to a use of the energy apparatus. The invention further relates to an electrode and/or to the use of the electrode.

### BACKGROUND OF THE INVENTION

Energy apparatuses are known in the art. For instance, WO2016178564 describes a method of storing varying or intermittent electrical energy and one or more of hydrogen (H₂) and oxygen (O₂) with an energy apparatus, the method comprising: providing the first cell aqueous liquid, the second cell aqueous liquid, and electrical power from an external power source to the functional unit thereby providing an electrically charged functional battery unit and one or more of hydrogen (H₂) and oxygen (O₂) stored in said storage system, wherein during at least part of a charging time the functional unit is charged at a potential difference between the first cell electrode and the second cell electrode of more than 1.37 V.

US2020028227A1 describes a method of storing varying or intermittent electrical energy and one or more of hydrogen (H₂) and oxygen (O₂) with an energy apparatus, the method comprising: providing the first cell aqueous liquid, the second cell aqueous liquid, and electrical power from an external power source to the functional unit thereby providing an electrically charged functional battery unit and one or more of hydrogen (H₂) and oxygen (O₂) stored in said storage system, wherein during at least part of a charging time the functional unit is charged at a potential difference between the first cell electrode and the second cell electrode of more than 1.37V.

US2015368811A1 describes an invention directed to mixed-metal catalysts, particularly nano-dimensioned layered double-hydroxide nanostacks, methods of making nanocatalysts using laser ablation techniques, and the electrochemical devices comprising and using these nanocatalysts, for example in the electrochemical oxidation of water.

### SUMMARY OF THE INVENTION

Annual electricity generation from renewable energy sources is growing rapidly. Renewable electricity sources may currently represent about 26% of the world's electricity and according to the International Energy Agency (IEA) it is expected to reach 30% by 2024. IEA expects solar energy to play the largest role in the rise of the renewable energy share. Due to their inherent intermittency, renewable energies can have a serious impact on the electricity market in times of over and under supply. This can lead to curtailment or depressed or even negative electricity prices caused by a serious mismatch of supply and demand. Germany's electricity prices have dropped below zero 22 times between 2011-2018. More recently in April 2020, during the Coronavirus crisis, hourly day-ahead power in Europe dropped to negative prices for 6 consecutive weeks. Besides, electricity prices may rise when a lack of renewable generation occurs and more and more fossil power backup is phased out. These examples indicate a need for developing large scale energy storage systems to stabilize the electricity grid by load balancing diurnal and seasonal cycles, especially when the supply of renewables starts to outgrow the instantaneous demand.

Hydrogen produced by electrolysis may be a promising solution for long-term energy storage conversion of electric energy as it may be stored easily and may offer high storage capacity. However, hydrogen storage may suffer from a roundtrip efficiency lower than other storage technologies.

Rechargeable batteries, with their high round trip efficiency, scalability and flexibility may be particularly good candidates to balance the electricity grid in the short timescale. In the last century, several battery systems have been developed but only a few have been demonstrated in large-scale applications, mainly lead-acid and lithium ion batteries. However, the deployment of such lead-acid batteries may be limited by their limited cycle lifetime (500-800 cycles), energy density (30-50 Wh/kg) and the toxicity of the raw materials. In addition the lead-acid battery may suffer also from poor high rate performance with a charging time of 8-15 hours. The lithium-ion battery may outclass the lead-acid performances with a longer lifetime (>1000 high depth of discharge cycles), good high-rate performances (charging time <1 hour) and an energy and power density among the highest reported for rechargeable batteries (170-250 Wh/g). High energy and power densities are primordial for applications that require compact and light storage devices (laptops, power tools, smartphones, electric vehicles).

However, different requirements are expected for stationary energy storage applications. Energy storage systems used for such an application ideally have extraordinarily long cycle lives, be capable of high power charge and discharge for minutes, have very high energy efficiency and, above all, have low capital and lifetime costs, which may not be (sufficiently) provided by the lithium-ion battery. Other limitations to the widespread deployment of the Li-ion battery for the grid-stabilization are the material cost and its low robustness. Li-ion shows indeed a low tolerance to overcharge and deep discharge which causes e.g. thermal runaway; additional and costly safety systems are then required for cooling the battery and to limit the battery discharge, e.g., to 80%.

The rechargeable Ni/Fe alkaline battery may present an interesting alternative for meeting the demands of grid scale electrical energy storage systems. Although the Ni/Fe battery shows a lower energy density than Lithium ion, its specific energy (50 Wh/g) is still 1 to 1.5 higher than for the lead-acid battery. On top of that, the Edison battery is well known for its extraordinary robustness (2000-5000 Cycles), and its tolerance to overcharge and deep discharges. The low cost and abundance of the raw materials required to produce Ni/Fe cells are also two important advantages of this technology. The Ni/Fe battery presents also some drawbacks such as the relatively costly Ni(OH)₂ used for the positive electrode but more importantly, the relatively low full cell energy efficiency (65-70%). This last point may explain the low interest received by the Ni/Fe technology recently. The reason in part being that when charging, the Ni/Fe forms NiOOH and metallic Fe which are known to be good catalysts for OER (oxygen evolution reaction) and HER (hydrogen evolution reaction) respectively, inducing a competitive water splitting reaction during the battery charge.

To overcome this efficiency issue, a hybrid alkaline battery-electrolyser device named battolyser with the Ni/Fe battery has been proposed previously where the hydrogen production is regarded as a main electrolysis fuel product for long term storage next to the battery function.

To improve this hybrid battery electrolyser further, the material cost may be reduced, the high rate performances may be improved and the energy efficiency may be further increased.

Hence, it is an aspect of the invention to provide an alternative energy apparatus, which preferably further at least partly obviates one or more of above-described drawbacks. The present invention may have as object to overcome or ameliorate at least one of the disadvantages of the prior art, or to provide a useful alternative.

Hence, in a first aspect the invention may provide an energy apparatus. The energy apparatus may comprise one or more functional units. Each functional unit may comprise one or more of a first cell, a second cell, a separator, and a charge control unit. The first cell may comprise a first cell electrode, especially wherein the first cell electrode comprises an iron-based electrode. The first cell may further comprise one or more first cell openings, especially wherein the one or more first cell openings are (configured) for a first cell aqueous liquid and for a first cell gas. The second cell may comprise a second cell electrode, especially wherein the second cell electrode comprises one or more metals, more especially wherein the one or more metals comprise 60-99.9 at. % nickel, and 0.1-35 at. % of a (trivalent) metal cation, especially iron. The second cell may further comprise one or more second cell openings, especially wherein the second cell openings are (configured) for a second cell aqueous liquid and for a second cell gas. In embodiments, the first cell and the second cell may share the separator. The separator may be configured to block transport of one or more of O₂ and H₂ from one cell to another. Especially, the separator may have permeability for at least one or more of hydroxide ions (OH⁻) monovalent sodium (Na⁺), monovalent lithium (Li⁺) and monovalent potassium (K⁺). In embodiments, the energy apparatus may further comprise a charge control unit. The charge control unit may be configured for applying a potential difference between the first cell electrode and the second cell electrode.

The energy apparatus of the invention may provide various benefits over the prior art. In particular, the second cell electrode may have various benefits over a (pure) nickel electrode.

Typically, with regards to an Ni/Fe system, the main cost of the active electrode material is in the nickel hydroxide compound, whereas iron has a relatively low cost. In terms of energy efficiency, the nickel electrode may also stand out for its lower intrinsic conductivity and for the OER overpotentials during electrolysis; both are determining parts of an energy efficiency loss. Relative to a nickel electrode, however, the second cell electrode may offer improved battery storage capacity per nickel atom, improved electronic and ionic conductivity, and reduced OER overpotentials in comparison to conventional nickel hydroxide materials.

In particular, the second cell electrode may have an α-Ni(OH)₂-form, which may have a higher theoretical specific capacity (about 490 mAh/g) in comparison to the typical β-Ni(OH)₂-form (about 289 mAh/g). This alpha phase may consist of positively charged β-Ni(OH)₂ layers intercalated by water molecules and anions, especially counter-anions of a nickel salt used for synthesis. The interlayer space may then be larger for the alpha phase (>7.6 Å) than for the beta phase (>4.6 Å), which may allow a better pathway for ionic transfer. However, in the highly dehydrating alkaline electrolyte of the Ni/Fe battery (6 M KOH), the alpha phase may generally rapidly convert to β-Ni(OH)₂. Here, however, the α-Ni(OH)₂ may be stabilized via partial substitution of Ni²⁺ in the hydroxide layer by trivalent metal cations, especially iron. Thus, the strength of the anion binding to the layer may be enhanced by the increase of positive charges in the layer, facilitating a stabilization of the alpha phase. Further, when overcharged, β-Ni(OH)₂ may easily turn to γ-NiOOH which may have a higher interlayer spacing, resulting in a large volume expansion of the electrode, while during charge, the α-Ni(OH)₂ may form γ-NiOOH which has a similar interlayer spacing of 7 Å. In particular, however, the α->γ transition may be more readily reversed with relatively smaller lattice changes than the β->γ transition; hence, the β->γ transition with its larger lattice changes, may result in internal connection problems. The stabilization of the alpha phase may therefore beneficially limit the electrode dimensional changes during (dis)charge and overcharge (i.e. electrolysis).

Hence, the metal cation may stabilize the nickel-based electrode in the alpha phase, which may provide a variety of benefits. In embodiments, the metal cation may be selected from the group comprising Co, Al, Zn, Fe, Mn, Ti, Cr, Sc, Zn, Mo, Y, La. In further embodiments, the metal cation may especially be a trivalent metal cation. In specific embodiments, the metal cation may be iron.

In particular, iron may offer the advantage of a good stability at the trivalent state; therefore, a high stability of the alpha/gamma couple may be provided. Another advantage of iron over other trivalent cations may be an oxygen evolution reaction (OER) catalytic behavior when combined with Ni as Fe—NiOOH. This property that has been considered a detrimental effect for the Ni/Fe battery may be particularly beneficial when considering the hybrid Ni/Fe battolyser application. Another advantage may be that the Fe³⁺ during overcharge and electrolysis may form partly Fe⁴⁺, which may further add to the capacity of the electrode.

Hence, in embodiments, the second cell electrode may comprise α-Ni₁₋ₓFeₓ(OH)₂. This material may have an increased storage capacity per Ni atom relative to a nickel electrode, which may also facilitate reducing overall material costs, may have an improved high rate performance and an improved energy efficiency of the hybrid Ni/Fe battery (due to an enhanced conductivity), and may limit structural fatigue induced by lattice expansions.

Hence, in specific embodiments, the invention may provide an energy apparatus, the energy apparatus comprising a charge control unit and one or more functional units, each functional unit comprising a first cell, a second cell, and a separator, wherein the first cell comprises a first cell electrode and one or more first cell openings for a first cell aqueous liquid and for a first cell gas, and wherein the first cell electrode comprises an iron-based electrode, wherein the second cell comprises a second cell electrode and one or more second cell openings for a second cell aqueous liquid and for a second cell gas, wherein the second cell electrode comprises one or more metals, wherein the one or more metals comprise 60-99.9 at. % nickel, and 0.1-35 at. % iron, and wherein the first cell and the second cell share the separator, wherein the separator is configured to block transport of one or more of O₂ and H₂ from one cell to another while having permeability for at least one or more of hydroxide ions (OH⁻) monovalent sodium (Na⁺), monovalent lithium (Li⁺) and monovalent potassium (K⁺), and wherein the charge control unit is configured for applying a potential difference between the first cell electrode and the second cell electrode.

The energy apparatus may have an electrical energy storage functionality and an electrolysis functionality. Hence, the apparatus may be a combination of a battery and an electrolyser. By charging the battery, the battery gets ready for use and further hydrogen is produced. Even when the battery is filled, hydrogen production can be continued. This provides a charged battery and hydrogen, which production can e.g. take place when no consumption of energy or energy carrier of the apparatus takes place. The term “energy” especially relates to electrical energy. The term “energy carrier” especially relates to hydrogen gas (H₂), which can be used as fuel, e.g. for direct propulsion of an engine, but which may also indirectly be used, e.g. in a fuel cell for the generation of electricity. Hence, the apparatus may especially be used as charging point for vehicles for electricity and/or hydrogen (and/or O₂) (see also below).

The apparatus may comprise a functional unit. However, in an embodiment of the energy apparatus, the apparatus may also comprise a plurality of functional units. Two or more of the functional units may be arranged (electronically) in series, e.g. to increase the voltage difference. However, two or more of the functional units may also be arranged parallel, e.g. to increase the current. Further, when there are more than two functional units, also a combination of arrangements in series and parallel arrangements may be applied.

Especially, the functional unit may comprise a first cell, comprising a first cell electrode and one or more first cell openings for a first cell aqueous liquid and for a first cell gas, wherein the first electrode especially comprises an iron based electrode, and a second cell, comprising a second cell electrode and one or more second cell openings for a second cell aqueous liquid and for a second cell gas, wherein the second electrode especially comprises one or more metals, more especially wherein the one or more metals comprise 60-99.9 at. % nickel, and 0.1-35 at. % of a (trivalent) metal cation, especially iron.

Each cell may at least comprise an opening for introduction of the respective aqueous liquids. The aqueous liquid used is especially a basic aqueous liquid, such as comprising one or more of KOH, LiOH, and NaOH. Especially, the concentration of OH⁻ is at least 3 mol/l. Especially, the concentration of the hydroxide (especially one or more of KOH, NaOH and LiOH) in water is in the range of 4.5-8.4 mol/L (25-47 wt. % for KOH). Hence, these openings, respectively, may be configured as inlets of recycled electrolyte with water added to maintain the chosen concentration of KOH, LiOH and/or NaOH.

The first cell aqueous liquid and the second cell aqueous liquid within the cells may especially be alkaline, such as comprising at least 0.1 mmol/l OH⁻, especially at least 3 mol/l OH⁻, even more especially at least 3 mol/l OH⁻, such as at least about 6 mol/l OH⁻. Hence, in embodiments, the first cell aqueous liquid may comprise at least 0.1 mmol/l OH⁻, especially at least 3 mol/l OH⁻, even more especially at least 3 mol/l OH⁻, such as at least about 6 mol/l OH⁻. In further embodiments, the second cell aqueous liquid may comprise at least 0.1 mmol/l OH⁻, especially at least 3 mol/l OH⁻, even more especially at least 3 mol/l OH⁻, such as at least about 6 mol/l OH⁻. The liquid in the cells may be supplemented with liquids from the aqueous liquid control system. Fresh water may not necessarily be alkaline, as the alkali in the cells may substantially be effectively not used. The “cell aqueous liquid” may also be indicated as electrolyte. Further, in embodiments, during operation of the energy apparatus, the first cell aqueous liquid in the first cell and the second cell aqueous liquid in the second cell may exchange OH⁻ via the separator, which may (essentially) equalize the OH⁻ concentrations.

Further, each cell may also comprise a further opening, especially configured for removal of the aqueous liquid and/or for removal of gas. The first cell gas especially comprises H₂ gas; the second cell gas especially comprises O₂. The aqueous liquid in the cell and the cell gas may escape from the same opening. Alternatively or additionally, two or more openings may be used, e.g. one for the removal of aqueous liquid and one for the removal of gas.

In such embodiments, the aqueous liquid may be flowed through each cell, where the flow aids in gas removal, cooling (or heating) when necessary and water refilling. Depending on the applied current per cm² electrode surface area the flow (in volume/area/time) may be for instance in the range of about 0.3 μl/cm²/h-3.5 ml/cm²/h (with the former value approximately corresponding to the value of 0.001 Å/cm², and the latter value approximately corresponding to the value of 10A/cm²; see elsewhere herein).

Further, each cell may comprise an electrode.

In particular, the first cell may comprise the first electrode, which especially comprises an iron-based electrode. The iron based electrode may comprise in a charged state essentially Fe (metal) and in a discharged state essentially Fe(OH)₂, as was the case in the Edison Ni—Fe battery.

The iron based electrode especially is produced following the procedure as follows. Iron is first dissolved in dilute H₂SO₄ and to produce ferrous sulphate. The latter is purified by recrystallization and roasted at 1070-1120 K. The roasted mass is washed thoroughly with water and then dried. The dried material is treated with hydrogen at 1020-1070 K for chemical reduction and again subjected to partial oxidation at 970-1070 K. This latter process yields a mixture of iron powder and magnetite. The mixture is blended with additional agents (Cu, FeS, HgO, etc.) and put into pockets made from perforated-steel sheet plated with nickel. The pockets are fixed over a suitable nickel-plated steel plate to form the negative electrode. Hence, especially the iron based electrode is made as described by Chakkaravarthy et al. in Journal of Power Sources, 35 (1991) 21-35, which is herein incorporated by reference, using perforated pockets made from Ni plated steel. The active iron material may further be bound by sintering, or may alternatively be bound by PTFE or polyethylene. Alternatively or additionally, the first electrode comprises conductive additives such as carbon or Ni. In contrast with the often described Ni—Fe battery the additives such as sulfides (FeS, Bismuth sulfide, HgO, etc.) or other to suppress hydrogen evolution are not used, or alternatively reduced in concentration, since in the battery electrolyser hydrogen evolution is aimed to be occurring at reduced overpotentials. Additives to reduce the hydrogen generation overpotential further may be a small mass percentage of the following: Ni—Mo—Zn codeposited with Fe, or alternatively Ni—S—Co, Ti₂Ni, nitrogen doped graphene, Ni—Mo—N, Ni(OH)₂ nanoparticles, Ni—Cr, nanocrystalline Ni₅P₄, Ru, RuO₂, AgNi, or the noble elements Pd, Pt, etc. The electrode porosity can be maintained during pressing the electrodes by adding e.g. NaCl to the electrode, pressing, and then leaching out the NaCl to introduce the porosity. The total electrode thickness in its pockets is 2-5 mm, more particularly around 3.5 mm. The term “first electrode” may also relate to a plurality of first electrodes.

The second cell may comprise the second electrode, which especially comprises one or more metals, more especially wherein the one or more metals comprise 60-99.9 at. % nickel, and 0.1-35 at. % of a (trivalent) metal cation, such as 1-30 at. % of a (trivalent) metal cation, especially 5-25 at. % of a (trivalent) metal cation, such as 10-25 at. % of a (trivalent) metal cation, especially 15-25 at. % of a (trivalent) metal cation. The metal cation may especially comprise iron. The nickel based electrode may comprise in a charged state essentially γ-Ni₁₋ₓFeₓOOH_{1-y} and in a discharged state essentially α-Ni₁₋ₓFeₓ(OH)₂. The α-phase material may have a layered structure, wherein an amount of anions and water may be intercalated between the layers depending on the Fe concentration, and may have a significant amount of disorder. The intercalated anions may—especially depending on the synthesis—comprise one or more of SO₄²⁻, OH⁻, Cl, CO₃²⁻. The anions may for instance lead to a composition Ni₁₋ₓFeₓ(OH)₂(SO₄)_{x/2} or alternatively Ni₁₋ₓFeₓ(OH)₂₊ₓ, and furthermore including intercalated water.

In embodiments, the one or more metals may comprise at least 60 at. % nickel, such as at least 65 at. % nickel, especially at least 70 at. % nickel. In further embodiments, the one or more metals may comprise at least 75 at. % nickel, such as at least 80 at. % nickel, especially at least 85 at. % nickel. In further embodiments, the one or more metals may comprise at least 90 at. % nickel, such as at least 95 at. % nickel.

In further embodiments, the one or more metals may comprise at least 0.1 at. % of the (trivalent) metal cation, such as at least 1 at. %, especially at least 3 at. %. In further embodiments, the one or more metals may comprise at least 5 at. % of the (trivalent) metal cation, such as at least 10 at. %, especially at least 13 at. %. In further embodiments, the one or more metals may comprise at least 15 at. % of the metal cation, such as at least 17 at. %, especially at least 18 at. %. In further embodiments, the one or more metals may comprise at least 19 at. % of the metal cation, such as at least 20 at. %. In further embodiments, the one or more metals may comprise at most 35 at. % of the metal cation, such as at most 30 at. %, especially at most 25 at. %. In further embodiments, the one or more metals may comprise at most 23 at. % of the metal cation, such as at most 22 at. %, especially at most 21 at. %.

In particular, in embodiments, the one or more metals may comprise at least 80 at. % of nickel and the metal cation (combined), especially at least 85 at. %, such as at least 90 at. %. In further embodiments, the one or more metals may comprise at least 95 at. % of nickel and the metal cation (combined), especially at least 97 at. %, such as at least 99 at. %, including 100 at. %. Hence, the one or more metals may, in embodiments (essentially) consist of nickel and a (trivalent) metal cation, especially of nickel and iron.

The phrase “wherein the one or more metals comprise 60-99.9 at. % X” and similar phrases herein indicate that 60-99.9% of the atoms in the one or more metals comprise X.

As indicated above, in the charged state, the second electrode may comprise γ-Ni₁₋ₓFeₓOOH_{1-y}. In particular, the second electrode may, during charging and/or in a charged state, comprise Ni⁴⁺. To compensate for this charge, the electrode material may comprise a reduced amount of H, as indicated by 1-y, wherein y may be selected from the range of 0-1. In particular, in embodiments, y>0, especially ≥0.05, such as ≥0.1.

In embodiments, the second electrode may be a solid electrode.

In further embodiments, the second electrode may have a (total) capacity selected from the range of 1 mAh/cm²-500 mAh/cm², wherein the cm² refers to the geometric surface area of the electrode. Hence, in embodiments, the second electrode may have a (total) capacity per (geometric) surface area (of the second electrode) selected from the range of 1 mAh/cm²-500 mAh/cm², such as selected from the range of 5 mAh/cm²-400 mAh/cm², especially from the range of 20 mAh/cm²-300 mAh/cm.

In further embodiments, the second electrode may have an areal capacity selected from the range of from the range of 1 mAh/cm²-500 mAh/cm², especially from the range of 5 mAh/cm²-400 mAh/cm², such as selected from the range of 20-200 mAh/cm².

In further embodiments, the second electrode may have a capacity in number of electrons exchanged per atom of nickel (NEE) of at least 0.9, such as at least, especially at least 1.2, such as at least 1.4, especially at least 1.5.

In further embodiments, the second electrode may have an electrode thickness selected from the range of 0.5-10 mm, such as from the range of 3-6 mm, especially wherein the thickness in defined perpendicular to the plane between the first electrode and the second electrode. In particular, the thickness may be defined along a first axis, wherein the first axis is perpendicular to a surface of the second electrode, and wherein the first axis intersects the first electrode.

An Fe-substituted nickel hydroxide material (α-Ni₁₋ₓFeₓ(OH)₂) may, for instance, be prepared by a chemical co-precipitation method. A solution of iron and nickel sulphate salts or alternatively iron and nickel chlorides or nitrate salts, may be mixed in a desired ratio and dropped into a 2M NaOH solution under stirring. The pH-value of the mixture solution may be controlled to be 13.2-13.4 during the whole synthesis. Alternatively, also a lower pH range in between 7.5 and 13.2 may be used. The precipitate may be separated from the solution by centrifugation and washed with deionized water (the procedure is especially repeated twice). The precipitate may then be dried in a vacuum oven at 50-60° C. until a constant weight is reached. The obtained materials may then be ball-milled at 200 RPM for 12 min. Subsequently, the prepared Fe-substituted nickel hydroxide material Ni(OH)₂, carbon super P and graphite may be ground together before adding a polyethersulfone (PES) solution to the mixture (e.g., 3-7 wt. % in NMP or DMSO) until obtaining a homogeneous slurry. For instance, about 50-90% of the doped nickel hydroxide material, and about 3-25 wt. % of the carbon super P and about 3-25 wt. % of graphite may be used. Alternatively or additionally a low volume percentage (1-10%) high aspect ratio metallic fibers of Ni or of stainless steel may be used, or carbon nano fibers. The slurry may then be pasted into a nickel foam, such as in a disk-shape of 1 cm diameter. The nickel foam can be pre-treated under ultrasound (for e.g., 3 min) in HCl (e.g., 4 wt. %) and (for e.g., 3 min) in acetone in order to remove the oxide layer. After pouring the active material into the nickel foam, the electrodes may be soaked in water to induce the precipitation of a polymer by a phase inversion process. The electrodes may then be dried under vacuum at 50-60° C. and pressed to a desired thickness (e.g., about 0.1-7 mm) to provide (or: “ensure”) a good electric contact between the foam and the active material. Finally, the electrodes may be wrapped into a perforated nickel tape or nickel coated perforated steel tape.

During use, the electrode material may comprise one or more of Fe²⁺, Fe³⁺, and Fe⁴⁺, or even all of Fe²⁺, Fe³⁺, and Fe⁴⁺. Similarly, during use the electrode material may comprise one or more of Ni²⁺, Ni³⁺, and Ni⁴⁺, or even all of Ni²⁺, Ni³⁺, and Ni⁴⁺. In particular, in embodiments, during at least part of a charging operation the electrode material may comprise one or more of Ni³⁺ and Ni⁴⁺, especially at least Ni³⁺, or especially at least Ni⁴⁺.

The valence of iron may be determined using Mossbauer spectrometry. Further, the valence of nickel and iron may be determined using a Rontgen absorption spectroscopy technique, especially using Extended X-ray Absorption Fine Structure (EXAFS), or especially using X-ray absorption fine structure (XAFS). Further, the relative amount of Ni and Fe may be determined using Inductively Coupled Plasma atomic emission spectroscopy (ICP).

The alpha phase may especially be determined using X-ray diffraction.

In particular, in the Fe-substituted nickel hydroxide material, the iron may partly substitute the nickel.

The phrase “the second cell electrode may comprise α-Ni₁₋ₓFeₓ(OH)₂”, and similar phrases, may especially indicate that during at least part of an operational state, the second electrode may comprise α-Ni₁₋ₓFeₓ(OH)₂. For instance, in specific embodiments during at least part of a charging time and/or during at least part of a discharging time, the second cell electrode may comprise α-Ni₁₋ₓFeₓ(OH)₂.

Nickel iron hydroxides, and similar systems, may comprise the metal elements nickel and iron. As indicated above, the metal elements may comprise in embodiments 60-99.9 at. % nickel and 0.1-35 at. % iron. Especially, at least 90 at. % of the metal elements are defined by nickel and iron, like at least 95 at. %. Hence, other metal elements may be available, but especially at maximum 17 at. %, such as at maximum about 10 at. %, like especially at maximum 5 or 2 at. %. As indicated above, the metals will especially be available as metal ions. Different valencies may be available of nickel. Further, also different valencies may be available of iron.

The first cell and the second cell may share a separator, but may be separated from each other by this separator. Hence, liquid electrolyte may not flow freely from one cell to the other via the separator but the electrolyte may make ionic contact. Also, hydrogen gas and/or oxygen gas may not flow from one cell to the other via the separator. However, the separator may be permeable for neutral H₂O and specific ions, such as to at least one or more of OH⁻ ions, neutral H₂O, monovalent sodium (Na⁺), monovalent lithium (Li⁺), and monovalent potassium (K⁺). In embodiments, the separator may be permeable for (neutral) H₂O. In further embodiments, the separator may be permeable for one or more of OH⁻ ions, monovalent sodium (Na⁺), monovalent lithium (Li⁺), and monovalent potassium (K⁺). Hence, the first cell and the second cell share the separator, wherein the separator is configured to block transport of one or more of O₂ and H₂ from one cell to another while having permeability for at least one or more of OH⁻ ions, neutral H₂O, monovalent sodium (Na⁺), monovalent lithium (Li⁺), and monovalent potassium (K⁺), especially all. Hence, especially the separator may have a relatively high ionic conductivity and a relatively low ionic resistance. For instance, the ionic resistance is lower than ≤0.3 Ω·cm² in 30 wt. % KOH solution (at 30° C.). The separator may e.g. comprise a membrane, such as electrolysis membranes known in the art. Examples of membranes may e.g. include alkaline resistant polymer membranes and polymer composite membranes, such as e.g. a Zirfon (from Agfa) membrane. Such membrane may e.g. consist of a polymer matrix in which ceramic micro-particles (zirconium oxide) are embedded. This body is reinforced internally with a mesh fabric made from monofilament polyphenylene sulphide (PPS) or polypropylene (PP) fabric. It has a controlled pore size of about 0.15 μm and bubble point (especially defined as gas pressure against one side of the membrane required to form bubbles at the other side where there is liquid) of about 2+/−1 bar (over pressure). Such membrane may be permanently hydrophilic, by incorporated metal oxide particles, perfectly wettable in water and most common electrolytes. Such membrane may be stable in strong alkaline (up to 6M KOH) and up to 110° C. The pore size may e.g. be in the range of about 0.05-0.3 μm, such as about 0.15 μm; the thickness may e.g. be in the range of about 100-1000 μm, such as about 500 μm. Between the separator and each electrode, a respective spacer may be configured. These spacers may include openings for transport of the aqueous liquids and providing access for these liquids to the respective electrode.

In further embodiments, the separator may be permeable for OH⁻ ions. In further embodiments, the separator may be permeable for monovalent sodium (Na⁺). In further embodiments, the separator may be permeable for monovalent lithium (Li⁺). In further embodiments, the separator may be permeable for monovalent potassium (K⁺).

In this way, a functional unit may be provided which is substantially closed, except for the herein indicated openings. For electrical connection, the electrodes may be connected with an electrical connection which is also accessible from external from the functional unit. Hence, the functional unit may further comprise a first electrical connection in electrical connection with the first cell electrode, and a second electrical connection in electrical connection with the second cell electrode.

For a good processing with the functional unit, the apparatus may comprise one or more of an aqueous liquid control system, a gas storage system, a pressure system, a charge control unit, a first connector unit, a second connector unit, and a control unit. Further, additionally the apparatus may comprise a thermal management system and/or thermal insulation. Especially, the energy apparatus may comprise all of these.

Hence, in an embodiment the energy apparatus may further comprise an aqueous liquid control system configured to control introduction of one or more of the first cell aqueous liquid and the second cell aqueous liquid into the functional unit. Such aqueous liquid control system may include one or more valves. Further, such aqueous liquid control system may—during operation—functionally be connected with a service pipe for water. In combination with the pressure system (see also below), the aqueous liquid may also be provided under pressure to the functional unit (see further also below). Further, the aqueous liquid control system may include storage for caustics, such as one or more of NaOH, LiOH, and KOH, especially at least KOH. The aqueous liquid control system may independently provide the liquid to the first cell and the second cell. Further, the aqueous liquid control system may include a return system, configured to receive the liquid downstream from the first cell and/or the second cell and reuse at least part of the first liquid and/or second liquid. The term “aqueous liquid control system” may also refer to a plurality of aqueous liquid control systems.

Further, in an embodiment the energy apparatus may further comprise a storage system configured to store one or more of the first cell gas and the second cell gas external from said functional unit. Hence, storage may be done external from the functional unit. To this end the apparatus may comprise a storage system configured to store H₂ and/or a storage configured to store O₂. At least, the apparatus may comprise a storage configured to store H₂. In combination with the pressure system (see also below), the storage system may also be configured to store the one or more of the first cell gas and the second cell gas under pressure (see further also below). The term “storage system” may also refer to a plurality of storage systems.

Hence, in an embodiment the energy apparatus may further comprise a pressure system configured to control one or more of (a) the pressure of the first cell gas in the functional unit, (b) the pressure of the first cell gas in the storage system, (c) the pressure of the second cell gas in the functional unit, and (d) the pressure of the second cell gas in the storage system. To this end, the pressure system may comprise a pump, a valve, etc. In an embodiment, the pressure system essentially comprises one or more valves. The term “pressure system” may also refer to a plurality of pressure systems. Especially when two or more different types of fluids have to be pressurized, two or more independent pressure systems may be applied.

In yet a further embodiment the energy apparatus may further comprise a charge control unit configured to receive electrical power from an external electrical power source (see also below) and be configured to provide said electrical power to said functional unit during at least part of a charging time at current (sometimes also indicated as “current strength”) that results in a potential difference between the first cell electrode and the second cell electrode of more than 1.55 V at 18° C. and 1.50V at 40° C., i.e. in practice thus at least 1.50 V. Starting from the discharged state the current is first applied to mainly charge the battery; by applying this current voltages reach up to 1.65V at 18° C. and 1.55V at 40° C. before the battery is approximately fully charged, i.e. in practice thus at least 1.55 V. Progressively more hydrogen is produced after the battery capacity is reached and the voltage can then reach up to 1.75V (at 18° C.) and 1.62V at 40° C., i.e. in practice thus at least 1.62 V. The energy efficiency of the battery functionality charging and the electrolytic gas production is calculated as the integral of the battery output current times its voltage integrated over discharge time plus the higher heating value (HHV) of the amount of hydrogen gas produced during charge and (self-)discharge over the total cycle, divided by the integral of the input current times its voltage over the charge time. It appears that very good results are obtained in terms of total energy efficiency, even when going well above the normal voltage upper limits of 1.65 (at 18° C.) or 1.55V (at 40° C.) (i.e. in practice thus at least 1.55 V) for Ni—Fe charging for full nominal charge, and especially when charging/inserting current far beyond the nominal capacity of the Ni and Fe battery electrodes. The charge control unit may include electronic devices to convert high voltages to the required voltage and/or to convert AC voltage to DC voltage. Especially, in an embodiment of the energy apparatus, the charge control unit configured to provide said electrical power to said functional unit during at least part of a charging time at a current that results in a potential difference between the first cell electrode and the second cell electrode selected from the range of 1.4-1.75 V. Best results in terms of battery electrochemical reversibility, gas amount production, and overall energy efficiency are obtained for applied currents that result in cell potentials in this voltage range.

In embodiments, during at least part of a charging time the potential difference is more than 1.37 V. In further embodiments, during at least part of a hydrogen generation time the potential difference is selected from the range of 1.37-3.0 V, especially from the range of 1.48-2.0 V.

For discharge best results may be obtained when discharge is continued to a level preferably not lower than 1.10V for the cell. The control system, optionally in combination with the charge control unit, may also be configured to control discharging of the functional unit. Discharging may be done to an industrial object or vehicle, etc., using electrical energy. However, alternatively or additionally, the functional unit may also be discharged to an electricity grid.

Further, the charge control unit may be configured to provide said electrical power to said functional unit during at least part of a charging time at a current corresponding to the nominal battery capacity C expressed in Ah divided by minimum of 2 h, i.e. C/time with time >2 h. Such applied currents may lead to a potential difference between the first cell electrode and the second cell electrode of especially more than 1.37 V, but especially at maximum not more than 2.0 V

As indicated above, the apparatus may further include thermal insulation, especially configured to keep loss of thermal energy from the functional unit low. Further, the apparatus may comprise a thermal management system, configured to keep the temperature of the unit equal to or below a predetermined maximum temperature, for instance equal to or below 95° C. Hence, in an embodiment, especially for large systems (such as 10 kW or more), the temperature of the cells is monitored and the applied charge and discharge currents may be reduced when the temperature rises above the set limit of 60° C. The thermal management system may at least partly be comprised by the control system, i.e. with respect to the controls. Further, the thermal isolation may be comprised by the thermal management system.

In embodiments the energy apparatus may further comprise a first connector unit for functionally coupling to a receiver to be electrically powered and the electrical connection. An example of a device may be a car (see also below). Hence, especially the apparatus may include a(n electrical) plug or a socket that can be connected to such device, which may thus especially include a socket or a plug. The first connector is especially configured to transfer electrical power from the apparatus to a receiver, such as an external device, such as a battery of such device, or to an electricity grid. The term “first connector unit” may also refer to a plurality of first connector units.

In embodiments the energy apparatus may further comprise a second connector unit for functionally connecting a device to be provided with one or more of the first cell gas and the second cell gas with said storage system. Hence, especially the apparatus may include a(n hydrogen gas) plug or a socket, that can be connected to such device, which may thus especially include a socket or a plug. The second connector is especially configured to transfer hydrogen gas from the storage to a receiver, such as an external device, such as a hydrogen storage unit of such device, or to a gas grid. The term “second connector unit” may also refer to a plurality of second connector units. Note that the receiver for the gas is not necessarily the same as the receiver for the electricity.

Yet, in an embodiment the energy apparatus may further comprise a control system configured to control one or more of the aqueous liquid control system (if available), the storage system (if available), the pressure system (if available), and the charge control unit (if available). The control system is especially configured to control the apparatus, and the individual elements, especially the aqueous liquid control system, the storage system, the pressure system, and the charge control unit. In this way, the charging and electrolysis process may be optimized at maximum efficiency, amongst others e.g. dependent upon the availability of electrical power from an external electrical power source and the consumption of electrical power and/or hydrogen gas. Hence, in a specific embodiment of the energy apparatus, the control system is configured to control the charge control unit as function of a charge status of the functional unit and an availability of electrical power from the external electrical power source. Yet further, the control system is configured to control the charge control unit as function of a charge status of the functional unit, the status of a gas storage (full or further fillable), and an availability of electrical power from the external electrical power source. Optionally, the charge control unit may also be configured to feed electricity back into the electricity grid. The control system may especially be configured to control the operation conditions of the energy apparatus as function of electricity demand and/or gas demand from one or more clients (like the devices herein indicated) and/or availability of electricity (in the grid). Hence, the control system may amongst others control one or more of temperature, liquid flow, voltage difference, voltage sign, etc., as function of the presence of external demand and/or the type of external demand (H₂ and/or electricity).

Yet, in a further aspect the invention also provides an energy system including the energy apparatus as defined herein. Such system may further include a power source, especially an electrical power source. Hence, an embodiment comprises an energy system comprising the energy apparatus as defined herein and an external (electrical) power source. The power source may be used to charge the functional unit (i.e. to charge the battery). The apparatus may be functionally connected to a mains. However, the apparatus may also be functionally connected to a local electrical power generator. For instance, a plant generating biomass or a site where biomass is collected, may include a device for converting biomass into electricity, which can be used for powering the apparatus. Likewise, a local wind turbine, or local wind turbines, or a local photovoltaic or local photovoltaics, or a local water turbine, or local water turbines, may be used to provide electrical power to the apparatus. Of course, such external power source may also be integrated in an electrical power infrastructure, which may include various renewable and conventional power plants. Hence, in an embodiment the external power source comprises one or more of a photovoltaic cell, a wind turbine, and a water turbine. Hence, the energy apparatus may be comprised in one or more of an electrical energy grid, a H₂ gas grid and an O₂ gas grid.

The term “energy apparatus” may also refer to a plurality of “energy apparatus”. Hence, in an embodiment the energy system may comprise a plurality of energy apparatus and a plurality of external power sources. These energy apparatus and external power forces are functionally associated, such as via an electricity grid. For instance, in an embodiment the energy apparatus are arranged remote from each other along highways and roads. The energy system may further include an electricity grid. Especially, the external power sources may be functionally coupled to this electricity grid. Also industry, houses, etc., may functionally be coupled to such electricity grid. Hence, in an embodiment the energy system may comprise a plurality of energy apparatus and a plurality of external power sources and an electricity grid.

Yet, in a further aspect the invention also provides a method of storing electrical energy and one or more of hydrogen (H₂) and oxygen (O₂) with a single battery electrolyser. Especially, the invention also provides a method of storing electrical energy and one or more of hydrogen (H₂) and oxygen (O₂) with the energy apparatus as defined herein, the method comprising providing the first cell aqueous liquid, the second cell aqueous liquid, and electrical power from an external power source to the functional unit thereby providing an electrically charged functional unit and one or more of hydrogen (H₂) and oxygen (O₂) stored in said storage system, wherein during at least part of a charging time the functional unit is charged at a potential difference between the first cell electrode and the second cell electrode of especially more than 1.37 V, even more especially at least 1.55 V. Even more especially, during at least part of a charging time a current is selected resulting in a potential difference between the first cell electrode and the second cell electrode that is selected from the range of 1.50-2.0 V, such as 1.55-1.75 V, like at least 1.6V. Further, especially a current density may be selected from the range of 0.001-10 Å/cm².

Hence, in an embodiment during at least part of a charging time a current is selected resulting in a potential difference between the first cell electrode and the second cell electrode that is selected from the range of 1.50-2.0 V, such as 1.55-1.75 V, like at least 1.6V. Further, especially a current density may be selected from the range of 0.001-10 Å/cm², such as 0.001-2 Å/cm². Hence, in an embodiment the charge control unit configured to provide said electrical power to said functional unit during at least part of a charging time at a potential difference between the first cell electrode and the second cell electrode selected from the range of 1.6-2.0 V and at a current density selected from the range of 0.001-10 Å/cm². Here, the area refers to the external area of the electrodes, as known in the art. For instance, an electrode having an area of 1 cm² with nickel material or iron material has an external area of 1 cm², notwithstanding the fact that the nickel material or iron material may have a very high surface area. Therefore, the term “external” area is used. Especially, the external area is defined by just the outside surface of the perforated metal pockets. Herein, instead of the term “external area” also the term “geometrical surface area” may be applied. The electrode material inside is especially nanostructured and may thus have a large surface area, e.g. in m²/g range, but here it is especially referred to a cross-sectional area (cross-section parallel to the plane of the electrode(s)). Especially, all current should also go through the separator, so that can also be used as a definition; it has about the same surface area as the external shape of the respective metal pockets, i.e. of the surface of the respective electrodes.

In yet a further embodiment, the method may comprise maintaining a first pressure in the first cell and a second pressure in the second cell at a pressure of at least 200 bar, such as in the range of 200-800 bar. Further, the method may also comprise maintaining a pressure in the storage over 1 bar, such as in the range of up to 800 bar, especially 200-800 bar. As indicated above, pressures in the first cell and second cell may be controlled independently of each other. Likewise, when both storing H₂ and O₂, the pressure of the H₂ and O₂ in the storage may be controlled independently, when desired.

During charging, the temperature of the functional unit is especially kept at a temperature in the range of −10-+60° C., even more especially at a temperature of at least 10° C. To this end, the energy apparatus may also include a temperature control unit. Especially, the control unit may be configured to limit the temperature of the functional element by reducing the applied current when the temperature rises above the set limits. Further, the apparatus, especially the functional unit, may include thermal isolation.

The energy apparatus and/or the energy system may in embodiments especially be used for providing one or more of electrical power, hydrogen (H₂) and oxygen (O₂) to a device. For instance, such device may be a battery (for electrical power), or a device comprising such battery, like a car. Such device may also be a hydrogen storage unit, or a device comprising such hydrogen storage unit. Further, such device may be an apparatus using oxygen in a production process. Hence, in an embodiment the energy apparatus and/or energy system are used for providing one or more of electrical power, hydrogen (H₂) to a motorized vehicle comprising an engine deriving its propulsion energy from one or more of a hydrogen source and an electrical power source. The vehicle may e.g. be a car requiring hydrogen, electrical power, or both. However, in other embodiments the device may be comprised by an industrial object, such as an apparatus using oxygen and/or hydrogen (chemical hydrogenation, ammonia synthesis, chemical reduction, etc.) in a production process. Such industrial object is especially configured to utilize one or more of electrical power, hydrogen and oxygen.

Hence, amongst others the invention provides a method of storing (varying or intermittent) electrical energy and one or more of hydrogen (H₂) and oxygen (O₂) with an energy apparatus, the method comprising: providing the first cell aqueous liquid, the second cell aqueous liquid, and electrical power from an external power source to the functional unit thereby providing an electrically charged functional battery unit and one or more of hydrogen (H₂) and oxygen (O₂) stored in said storage system, wherein during at least part of a charging time the functional unit is charged at a potential difference between the first cell electrode and the second cell electrode of more than 1.37 V. In further embodiments, during at least part of a hydrogen generation time the potential difference may be selected from the range of 1.37-3.0 V, especially from the range of 1.48-2.0 V.

In embodiments, the one or more metals may comprise at least 0.1 at. % of the (trivalent) metal cation, such as at least 1 at. %, especially at least 2 at. %, such as at least 3 at. %, especially at least 5 at. %, such as at least 10 at. %, especially at least 15 at. %, such as at least 17 at. %, especially at least 18 at. %, such as at least 19 at. %.

In further embodiments, the one or more metals may comprise at most 35 at. % of the (trivalent) metal cation, such as at most 32 at. %, especially at most 30 at. %, such as at most 28 at. %, especially at most 25 at. %, such as at most 23 at. %, especially at most 22 at. %, such as at most 21 at. %, especially at most 20 at. %.

In further embodiments, the one or more metals may comprise at least 60 at. % nickel, such as at least 65 at. % nickel, especially at least 70 at. % nickel, such as at least 75 at. % nickel, especially at least 80 at. % nickel, such as at least 85 at. % nickel.

In further embodiments, the one or more metals may comprise at most 99.9 at. % nickel, such as at most 99 at. % nickel, especially at most 95 at. % nickel, such as at most 90 at. % nickel, especially at most 85 at. % nickel.

In further embodiments, the one or more metals may further comprise a metal selected from the group comprising Ti, Cr, Mn, Co, Zn, Sc, Al, Ru, Mo, Zr, Sn, Cu, Al, Y, and La. In further embodiments, the one or more metals may especially comprise at least Cu.

In embodiments, the energy apparatus may comprise two or more first cell electrodes and (b) two or more second cell electrodes, especially wherein the energy apparatus further comprises an electrical element configured for applying one or more of (a) a first potential difference between two or more first cell electrodes and (b) a second potential difference between two or more second cell electrodes. With such apparatus it may be possible to discharge and generate H₂ at the same time, as may be further described in WO2018117839A1, which is hereby herein incorporated by reference. Further, with such apparatus it is possible to store electricity, when charging the apparatus, and generate hydrogen and oxygen.

In further embodiments, the electrical element may be configured for applying a potential difference between a first subset of the two or more first cell electrodes and a second subset of the two or more first cell electrodes, wherein the first cell electrodes of the first subset comprise iron-based electrodes, and wherein the first cell electrodes of the second subset comprise either iron-based electrodes or hydrogen gas generating electrodes (different from the first cell electrodes of the first subset). The electrodes from the first subset may differ in material from the second subset. For instance, in embodiments the first cell electrodes of the second subset comprise one or more of platinum (Pt), NiMo, NiFeₓ, FeMoₓ, NiCoFe, LaNi₅ and LaNi₅ type materials such as MmNi_{5-x-y}CoₓAl_{y} where Mm stands for a mix of two or more lanthanides, and molybdenum sulfide (MoSₓ). MmNi_{5-x-y}CoₓAl_{y} is a LaNi₅ type compound. Mm may especially comprise one or more of Ce, La, Pr, and other rare earth elements (including Y). Further, x and y are chosen, as known in the art, to be equal or larger than zero. Especially, one or more electrodes of the first subset comprise Fe and one or more electrodes from the second subset comprise Pt. Other options can be tungsten sulfide (WSₓ) or selenide (WSeₓ), and molybdenum sulfide (MoSₓ). Here, x is especially in the range of 1.9-2.1, or 1 to 3. Especially, these materials may be used as catalyst (for addition to e.g. Fe comprising electrodes). These sulfide materials are produced to have a high specific surface area larger than 1 m²/g or 10-50 m²/g, or up to 500 m²/g.

In a further aspect, the invention may provide a use of the energy apparatus according to the invention or the energy system according to the invention, for providing one or more of electrical power, hydrogen (H₂) and oxygen (O₂) to a receiver.

In a further aspect, the invention may provide the second cell electrode as such. Hence, the invention may provide a (second cell) electrode, wherein the electrode comprises an electrode material, wherein the electrode material comprises one or more metals, wherein the one or more metals comprise 60-95 at. % nickel, and 5-30 at. % of a (trivalent) metal cation, especially iron.

In embodiments, the one or more metals may comprise 17-23 at. % iron, and especially at least 70 at. % nickel.

In embodiments, the electrode may comprises α-Ni(OH)₂, especially with a rhombohedral structure, more especially having space group R3m. In embodiments, the structure of the electrode material may have a larger c-axis length than a conventional Ni(OH)₂ electrode, which may provide improved structural stability. This c-axis extension may be a result of water and counter ion intercalation during the synthesis. In embodiments, at least part of the Ni in the rhombohedral structure may be replaced by Fe. In further embodiments, the second electrode, especially the electrode material, may comprise intercalated anions, such as one or more of SO₄²⁻, OH⁻, Cl⁻, and CO₃²⁻.

Hence, in embodiments, the electrode material may comprise ≥3 wt. % (intercalated) water, such as ≥5 wt. % (intercalated) water, especially ≥7 wt. % (intercalated) water, such as ≥10 wt. % (intercalated) water, especially ≥15 wt. % (intercalated) water. In further embodiments, the electrode material may comprise ≤30 wt. % (intercalated) water, such as ≤25 wt. %, especially ≤23 wt. %, such as ≤20 wt. %.

In embodiments, the electrode, especially the electrode material, may further comprise a conductive additive selected from the group comprising stainless steel fiber, nickel fiber, carbon fiber, atomized nickel, or stainless steel particles. In further embodiments, the electrode, especially the electrode material, may comprise 0.3-20 volume percent of the conductive additive, especially 0.5-10 volume percent. Such embodiments may especially have a (further) improved conductivity.

In a further aspect, the invention may provide a use of the (second) electrode according to the invention in an integrated battery and electrolysis apparatus.

In a further aspect, the invention may provide a method for assembling a functional unit. The method for assembling the functional unit may especially comprise functionally coupling the first cell, the second cell, and the separator.

In a further aspect, the invention may provide a method for assembling an energy apparatus. The method for assembling the energy apparatus may especially comprise functionally coupling the functional unit and the charge control unit.

In embodiments, the method for assembling the energy apparatus may comprise executing the method for assembling the functional unit.

In a further aspect, the invention may provide a method for assembling an energy system. The method for assembling the energy system may especially comprise functionally coupling the energy apparatus and the external power source.

In embodiments, the method for assembling the energy system may comprise executing the method for assembling the energy apparatus.

Further features of the energy apparatus may be described in WO2016178564, which is hereby herein incorporated by reference.

The embodiments described herein are not limited to a single aspect of the invention. For example, an embodiment describing the method may, for example, further relate to the system, especially to an operational mode of the system, or especially to the control system. Similarly, an embodiment of the system describing an operation of the system may further relate to embodiments of the method. In particular, an embodiment of the method describing an operation (of the system) may indicate that the system may, in embodiments, be configured for and/or be suitable for the operation.

### BRIEF DESCRIPTION OF THE DRAWINGS

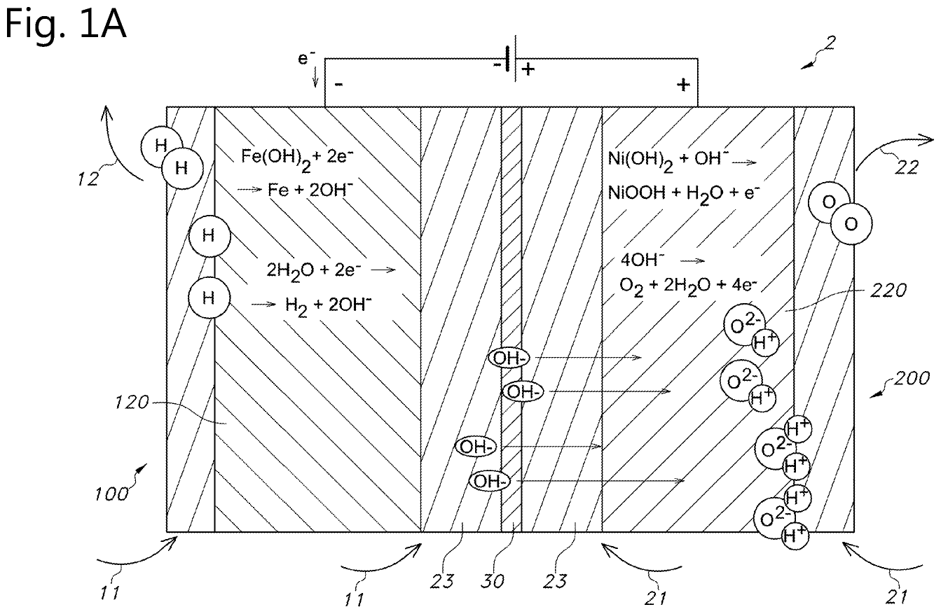

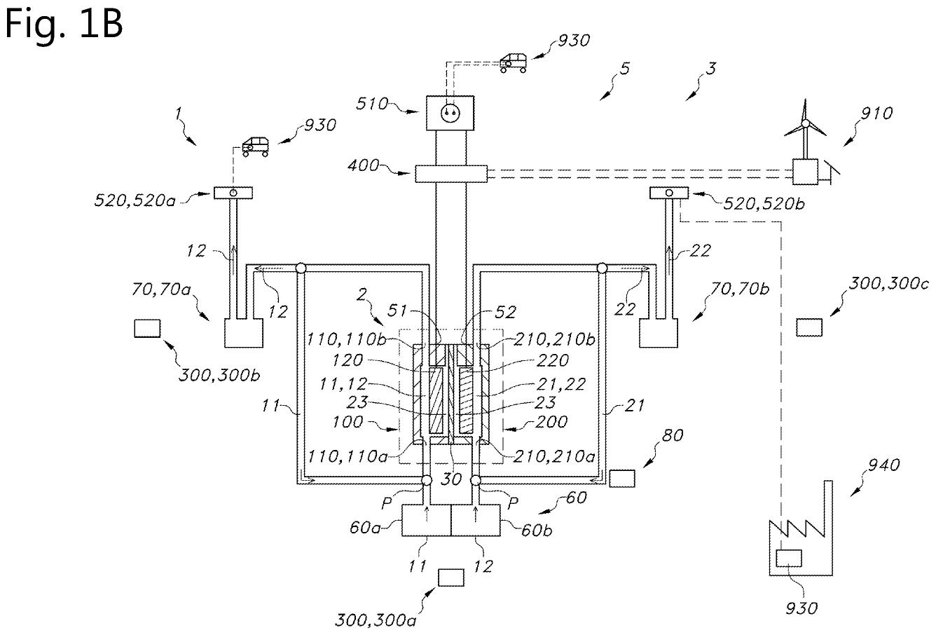

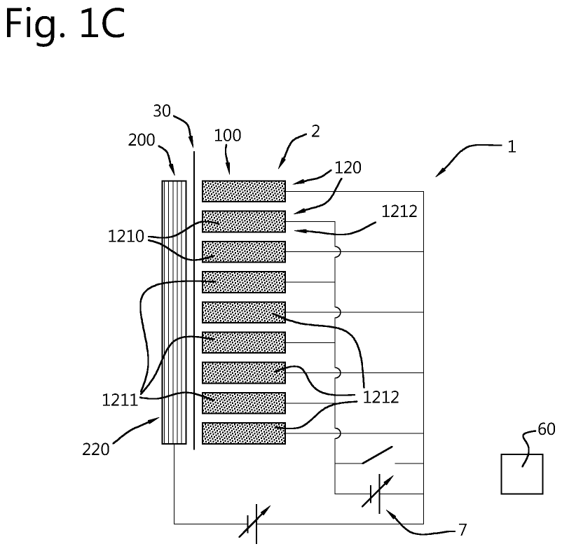

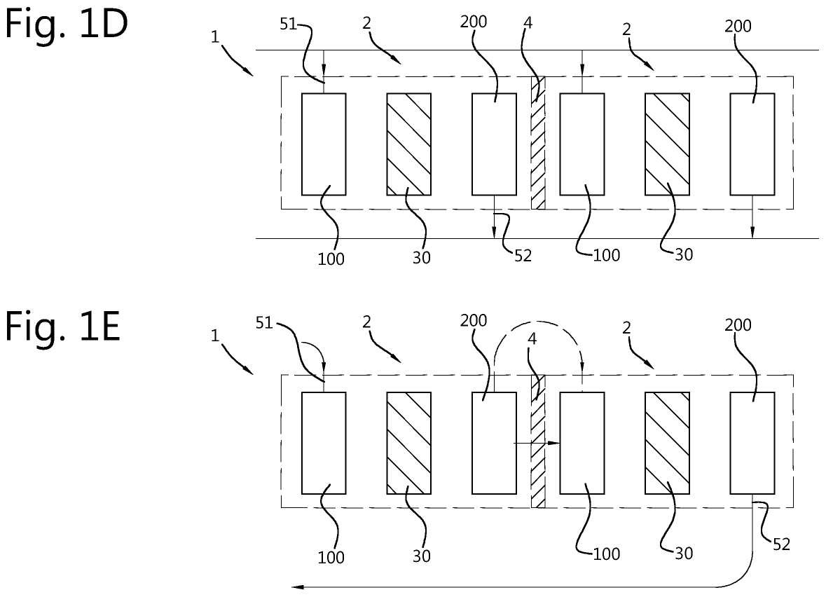

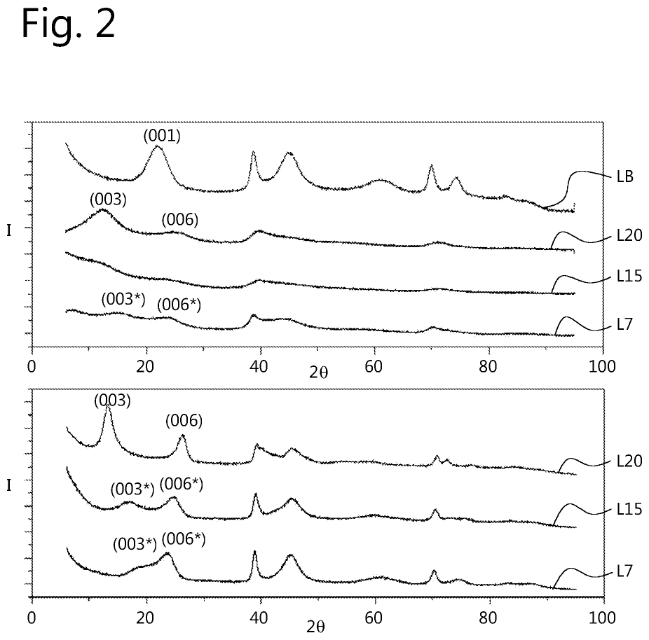

Embodiments of the invention will now be described, by way of example only, with reference to the accompanying schematic drawings in which corresponding reference symbols indicate corresponding parts, and in which: FIG. 1A-E schematically depict embodiments of aspects of the invention; FIG. 2-5 schematically depict experimental results. The schematic drawings are not necessarily on scale.

### DETAILED DESCRIPTION OF THE EMBODIMENTS

FIG. 1A schematically depicts some aspects of an embodiment of a functional unit 2. More details are shown in the embodiment of FIG. 1B. FIGS. 1A (and 1B) schematically show the functional unit 2 comprising: a first cell 100, a second cell 200, and a separator 30. The first cell 100 comprises a first cell electrode 120. Especially, the first electrode 120 comprises an iron based electrode. The second cell 200 comprises a second cell electrode 220. The second electrode 220 especially comprises one or more metals, wherein the one or more metals may comprise 60-99.9 at. % nickel and 0.01-35 at. % of a metal cation, especially a trivalent metal cation, such as (trivalent) iron. Further, the first cell 100 and the second cell 200 may share the separator 30. The separator is configured to block transport of one or more of O₂ and H₂ from one cell to another while having permeability for at least one or more of OH⁻, monovalent sodium (Na⁺), monovalent lithium (Li⁺) and monovalent potassium (K⁺). The separator 30 may especially comprise a membrane. Further, the separator 30 and the electrodes 120 and 220 may be spaced apart with a spacer, indicated with reference 23. This spacer may be configured to provide a spacing between the electrode and the separator, but also allow the water based electrolyte to come into contact with the electrode at the separator side of the electrode. Hence, first and second cell aqueous liquids 11,21 may pass at both sides of the respective electrodes 120,220.

The separator 30 and the respective electrodes 120,220 may substantially have the same surfaces areas, i.e. external surface areas, and may thereby form a stack (with especially the spacers in between). Hence, the electrodes and the separator may substantially have the same heights (as depicted here) and the same width (here the plane perpendicular to the plane of drawing).

Especially, the functional unit 2 is an integrated unit substantially entirely enclosed by pressure containment. As will be further also described below, the functional unit may comprise a plurality of first cells and second cells.

During charging, the following reaction may take place at the first electrode 120: Fe(OH)₂+2e⁻⇒Fe+2OH⁻ (−0.877 V vs. SHE), followed by 2H₂O+2e⁻⇒H₂+OH⁻ (−0.83 vs. SHE). Hence, when the battery is charged, Fe may act as a catalyst for H₂ formation. Further, during charging at the second electrode 220, the following reaction may take place: Ni(OH)₂+OH⁻⇒NiOOH+H₂O+e⁻ (+0.49 V vs. SHE), followed by 4OH⁻⇒O₂+2H₂O+4e⁻ (0.40 vs. SHE). When the battery is charged, the NiOOH acts as O₂ evolution catalyst with some overpotential with respect to the O₂ evolution equilibrium potential.

FIG. 1A shows electrolysis reactions. When the arrows are reversed, discharge reactions are indicated. Hence, the open cell potential (for discharging) may be 1.37 V. The equilibrium potential for electrolysis may be 1.23 V; however, for having significant O₂ and H₂ evolution overpotentials may be required with respect to the equilibrium potentials. In addition the thermo neutral potential for splitting water is 1.48V, taking into account also heat that is required if that is to be generated only from the applied potential during electrolysis. In the present invention, however, heat may also be available from the overpotentials of the battery charging, which may provide some additional heat. In practice during electrolysis the potential may rise to (at least) 1.55-1.75 V. Heat from overpotentials may therefore be available for the electrolysis. A remarkable fact is that the battery can be charged first although the potential energy levels are very close to the H₂ and O₂ evolution potentials.

FIG. 1A further schematically depicts a use of the (second) electrode according to the invention in an integrated battery and electrolysis apparatus.

FIG. 1B schematically depicts an embodiment of the energy apparatus 1 having an electrical energy storage functionality and an electrolysis functionality. The system 1 comprising the functional unit 2 (see also above). The first cell 100 comprises a first cell electrode 120 and one or more first cell openings 110 for a first cell aqueous liquid 11 and for a first cell gas 12. The second cell 200 comprises a second cell electrode 220 and one or more second cell openings 210 for a second cell aqueous liquid 21 and for a second cell gas 22, wherein the second cell electrode 220 comprises a nickel based electrode.

Further, a first electrical connection 51 in electrical connection with the first cell electrode 120, and a second electrical connection 52 in electrical connection with the second cell electrode 220, are depicted. These may be used to provide electrical contact of the electrodes 120,220 with the external of the functional unit 2.

The energy apparatus 1 further comprises an aqueous liquid control system 60 configured to control introduction of one or more of the first cell aqueous liquid 11 and the second cell aqueous liquid 21 into the functional unit 2. The liquid control system 60 by way of example comprises a first liquid control system 60a and a second liquid control system 60b. The former is functionally connected with a first inlet 110a of the first cell 100; the latter is functionally connected with a first inlet 210a of the second cell 200. The aqueous liquid control system 60 may include recirculation of the aqueous liquid (and also supply with fresh aqueous liquid (not shown in detail)).

The energy apparatus 1 may further comprise a plurality of valves P. In particular, the system may comprise a valve P configured to combine recycled and fresh first cell aqueous liquid 11 prior to it entering the functional unit 2. Similarly, the energy apparatus 1 may comprise a valve P configured to combine recycled and fresh second cell aqueous liquid 21. The energy apparatus 1 may further comprise a valve P configured to separate the first cell gas and the first cell aqueous liquid, and a valve configured to separate the second cell gas and the second cell aqueous liquid.

Yet further, the apparatus 1 comprises a storage system 70 configured to store one or more of the first cell gas 12 and the second cell gas 22 external from said functional unit 2. The storage by way of example comprises a first storage 70a and a second storage 70b. the former is functionally connected to a first outlet 110b of the first cell 100; the latter is functionally connected to a first outlet 210b of the second cell 200. Note that e.g. only the first storage 70a may be available, i.e. a storage for hydrogen gas. Separation between gas and liquid, upstream of the storage and/or downstream from the first cell 100 or the second cell 200 may be executed with a H₂ valve and/or a H₂O dryer and an O₂ deoxidizer as they are known in the art, or with a O₂ valve and/or a H₂O/H₂ condenser, respectively.

The energy apparatus 1 further comprises a pressure system 300 configured to control one or more of (a) the pressure of the first cell gas 12 in the functional unit 2, (b) the pressure of the first cell gas 12 in the storage system 70, (c) the pressure of the second cell gas 22 in the functional unit 2, and (d) the pressure of the second cell gas 22 in the storage system 70. The pressure system may e.g. include different pressure systems, which may be independent from each other or may be connected. By way of example a first pressure system 300a is depicted, especially configured to provide one or more of the first cell liquid 11 and the second cell liquid 21 under pressure to the first cell 100 and second cell 200, respectively. Further, another pressure system 300b may be configured to control the pressure of the storage for the first cell gas 12. Yet, another pressure system 300c may be configured to control a pressure of the storage for the second cell gas 22. Further, the pressure system 300 may be configured to control the pressure in the first cell 100 and/or the second cell 200. To this end, the pressure system may include one or more pumps, one or more valves, etc.

Yet, the apparatus in this embodiment also comprises a charge control unit 400 configured to receive electrical power from an external electrical power source (reference 910, see further below) and configured to provide said electrical power to said functional unit 2 during at least part of a charging time at a potential difference between the first cell electrode 120 and the second cell electrode 220 of especially more than 1.37 V during the first battery charge and between 1.37 and 3.0V during electrolysis when the battery is already fully charged, especially larger than 1.48V and up to 2.0V during electrolysis when the battery is already fully charged.

Schematically depicted are also a first connector unit 510 for functionally coupling a device 930 to be electrically powered and the electrical connection 51,52, as well as a second connector unit 520 for functionally connecting a device to be provided with one or more of the first cell gas 12 and the second cell gas 22 with said storage system 70. Here, in fact two second connector units 520 are depicted, a first second connector unit 520a, functionally connected with the first storage 70a, and a second connector unit 520b, functionally connected with the second storage 70b.

The apparatus may be controlled by a control system 80, which may especially be configured to control at least one of the aqueous liquid control system 60, the storage system 70, the pressure system 300, and the charge control unit 400, and especially all of these.

FIG. 1B also schematically depicts an embodiment of an energy system 5 comprising the energy apparatus 1 and an external power source 910, here by way of example comprising a wind turbine and a photovoltaic electricity generation source. The apparatus 1 or energy system 5 may be used for providing one or more of electrical power, hydrogen (H₂) to device 930, such as a motorized vehicle comprising an engine deriving its propulsion energy from one or more of a hydrogen source and an electrical power source. Alternatively or additionally, apparatus 1 or energy system 5 may be used by an industrial object 940, comprising such device 930. Here by way of example, the industrial object uses O₂ for e.g. a chemical process. Hence, of course alternatively or additionally, the first storage 70a may also be functionally coupled to a gas grid; likewise, the second storage 70b may be functionally coupled to a gas grid.

FIG. 1B also schematically depicts an electricity grid 3.

FIG. 1B also indicates a return system for aqueous liquid (see also above).

FIGS. 1A and 1B also schematically depict the second cell electrode 220.

FIG. 1C depicts a further embodiment of the energy apparatus 1. The energy apparatus 1 comprises one or more functional units 2. Here, a single functional unit 2 is schematically depicted. Each functional unit 2 comprises a first cell 100, comprising one or more first cell electrodes 120 and one or more first cell openings (not depicted for visualization purposes) for a first cell aqueous liquid (not depicted) and for a first cell gas (not depicted), a second cell 200, comprising one or more second cell electrodes 220 and one or more second cell openings 210 for a second cell aqueous liquid (not depicted) and for a second cell gas (not depicted); and a separator 30, wherein the first cell 100 and the second cell 200 share the separator 30, wherein the separator is configured to block transport of one or more of O₂ and H₂ from one cell to another while having permeability for at least one or more of hydroxide ions (OH⁻) monovalent sodium (Na⁺), monovalent lithium (Li⁺) and monovalent potassium (K⁺).

In embodiments, the energy apparatus 1 may comprise one or more of(a) at least two or more first cell electrodes 120 and (b) at least two or more second cell electrodes 220. In the embodiment depicted in FIG. 1C, the energy apparatus 1 comprises a single second cell electrode 220 and a plurality of first cell electrodes 120.

The energy apparatus 1 further comprises an electrical element 7 configured for applying one or more of (a) one or more potential differences between two or more first cell electrodes 120 and (b) one or more potential differences between two or more second cell electrodes 220. Here, the electrical element 7 is configured for applying a potential difference between two types of first cell electrodes 120 and run a current between them. Hence, the electrical element 7 is configured for applying a potential difference between a first subset 1211 of one or more first cell electrodes 120 and a second subset 1212 of one or more first cell electrodes 120. Note that not always this potential difference has to be applied. During a stage there may be applied such potential difference; however in other stages, such as when there is enough H2, no potential difference needs to be applied. For instance, the first cell electrodes 120 of the first subset 1211 and the second subset 1212 may comprise iron based electrodes. In further embodiments, the first cell electrodes 120 of the first subset 1211 comprise iron based electrodes, and wherein the first cell electrodes 120 of the second subset 1212 comprise hydrogen gas generating electrodes 1210.

FIGS. 1D-1E schematically depict embodiments wherein the apparatus 1 comprises a plurality of functional units 2 (or “units 2”), either arranged parallel (1D) or in series (1E). Also combinations of parallel and in series arrangements may be applied. Referring to FIG. 1D, wherein the units 2 are configured parallel, the units 2 may be separated by a unit separator 4. The unit separator may especially fluidically separate the electrolyte of the (parallel configured) units (2). In further embodiments, the units 2 may be configured in a single bath comprising the electrolyte (i.e. water comprising especially KOH), thus with the unit separator 4 replaced by a separator 30, which separator 30 may be configured to block transport of one or more of O₂ and H₂ from one unit to another, especially while having permeability for at least one or more of OH⁻ ions, neutral H₂O, monovalent sodium (Na⁺), monovalent lithium (Li⁺), and monovalent potassium (K⁺), more especially for all. Referring to FIG. 1E, wherein the units 2 are configured in series, it may be necessary to introduce a unit separator 4. This unit separator 4 may for instance comprise a bipolar plate, such as a nickel-coated bipolar plate. The electrolyte may contain e.g. at least 5M KOH, such as about 6 M KOH. Though separators 30 may separate the first cell 100 and the second cell 200, in embodiments the electrolyte may flow from the first cell to the second cell, or vice versa, or from a first cell of a first functional unit to a second cell of a second functional unit, or vice versa, etc.

An advantage of arranging the units 2 in series is that application of the electrical connections may be much easier. For instance, when using bipolar plates configured between units, one may only need a first electrical connection 51 with a first cell electrode (not depicted) of first cell 100 of a first functional unit 2, and a second electrical connection 52 with a second cell electrode (not depicted) of second cell 100 of a second functional unit 2. Current may then travel through a bipolar plate 4 from one (electrode from one) functional unit 2 to another (electrode from another) functional unit 2 (see arrow through bipolar plate 4). A further advantage of the series arrangement is that battery management may be easier than in the parallel case, as providing charge beyond full capacity of one of the cells results in the (desired) generation of H₂ somewhat earlier than in the other cells, without adverse effects. During discharge beyond the full capacity of an individual cell the voltage drop can be monitored not to go below 1.1V per individual cell and also O₂ can be made available for reduction in the electrolyte at the Ni based electrode, e.g. by inserting O₂ from the bottom water entrance of the cell, bubbling and diffusing into the electrode. The O₂ can be produced and stored during the preceding charge periods of the device.

The plurality of functional units 2 may be configured as stacks. Especially referring to the stack in series, a construction may be provided comprising [ABACADAE]n, wherein A refers to an electrolyte and dissolved gas distribution sheet (such as shaped porous propylene), B refers to the first electrode or the second electrode, C refers to a bi-polar plate, such as a Ni-coated bipolar plate, D refers to the second or the first electrode (with B≠D), E refers to a gas separation membrane, and n refers to an integer of 1 or larger. Note that equally well the stack may be defined as [CADAEABA]n or [ADAEABAC]n, etc. The whole stack may be contained in a pressure containment.

### EXPERIMENTS

Material preparation—Fe-substituted nickel hydroxide material (α-Ni₁₋ₓFeₓ(OH)₂) containing 7 at. % (x=7), 15 at. % (x=15), 20 at. % (x=20) (indicated here as NiFe7, NiFe15, NiFe20), were prepared by a simple chemical co-precipitation method. A solution of iron and nickel sulphate salts mixed in the appropriate ratio was slowly dropped into a 2M NaOH solution under stirring. The pH-value of the mixture solution is controlled to be 13.2-13.4 during the whole synthesis. The precipitate was separated from the solution by centrifugation and washed with deionized water (the procedure is repeated twice). The precipitate was then dried in a vacuum oven at 50-60° C. until a constant weight was reached. The obtained materials were then ball-milled at 200 RPM for 12 min. For comparison purposes, a pure β-Ni(OH)₂ was synthesized following the same protocol.

Material characterization—The phase structure of the as-prepared and aged samples was identified using a Bruker D8 Advance diffractometer with Co Kα source (λ=1.78890 Å, 35 kV and 40 mA) and LynxEye position sensitive detector. The scan data were collected in a 20 range of 5-95° with a step size of 0.060 and a counting time of 15 s. TG. and DTA measurements were performed using a TGA2 from Mettler Toledo under air flow and in a temperature range of 30-800° C. with a step of 10° C. per minute. The metal content of the prepared samples was analyzed using the ICP-OES, Spectro Arcos EOP.

Electrode preparation—Pasted nickel electrodes were prepared as follows: 50% of Ni(OH)₂, 25% of carbon super P and 25% of graphite were ground together before adding a polyethersulfone (PES) solution to the mixture (7 wt. % in NMP) until obtaining a homogeneous slurry. The slurry was then pasted into a nickel foam which was cut beforehand in a disk-shape of 1 cm diameter, and treated under ultrasound 3 min in HCl (4 wt. %) and 3 min in acetone in order to remove the oxide layer. After pouring the active material into the nickel foam, the electrodes were soaked in water to induce the precipitation of the polymer by a phase inversion process 54. The electrodes were then dried under vacuum at 50-60° C. and pressed to a thickness of 0.1 mm (⅕ of the initial thickness) to provide (or “ensure”) a good electric contact between the foam and the active material. Finally, the electrodes were wrapped into a nickel perforated tape. A blank electrode was prepared following the same protocol but without adding nickel hydroxide to the slurry.

Electrochemical characterization—The electrochemical tests were performed in a three-electrodes cell, the working, the counter and the reference electrodes being respectively the Ni(OH)₂ pasted electrode, a nickel foil and a Hg/HgO (6 M KOH) reference electrode. The potential of the Hg/HgO reference electrode was estimated using: E(Hg/HgO)=0.098−(R.T/F).ln[OH⁻]=0.052 V/SHE. The pasted electrodes were soaked in the electrolyte (6 M KOH solution) 10 hours before starting the electrochemical tests. The electrochemical performances including activation cycles, long-term cycling and high-rate acceptance tests were conducted using a Maccor 4000 battery cycling system. The theoretical capacity, for all samples, was calculated from the total mass of Ni(OH)₂ material loaded in the electrode and considering the maximum number of electrons exchanged that has been reported in literature for a nickel hydroxide sample (1.7 e− per Ni 24). For all charge cycling experiments the charge inserted was 1.5 times the theoretical capacity and the (dis)charge rate was 0.2C unless mentioned otherwise. The discharge capacity values were corrected by the blank electrode discharge capacity corresponding to the formation and reduction of nickel oxide formed on the nickel substrate when cycling. Tafel plots were obtained on the already charged materials by chronopotentiometry with current densities from 2.5 mA/cm2 to 25 mA/cm2. For this experiment, a rotating bar is placed below the working electrode to remove the generated bubbles. The oxygen evolution reaction potential E_{OER} were corrected with ohmic drop (iR) compensation and the OER overpotential at 10 mA/cm2 is estimated using: η_{OER}=E_{OER}−1.23+0.059.pH+0.052.

Results and Discussion

Material characterization—XRD patterns of the as-prepared Ni—Fe layered double hydroxide (NiFe-LDH) materials and a pure Ni(OH)₂ material (synthesized following the same protocol) are shown in FIG. 2. Specifically, FIG. 2 depicts intensity (I; in a.u.) vs. 2θ, wherein reference L7 corresponds to NiFe7, reference L15 corresponds to NiFe15, reference L20 corresponds to NiFe20, and reference LB corresponds to the nickel hydroxide material prepared without iron substitution. In particular, the top part of FIG. 2 represents measurements pertaining to the as prepared materials, whereas the bottom part depicts XRD patterns of the iron doped α-Ni(OH)₂ after 1 month of ageing in KOH (6 M).

As expected, the nickel hydroxide material prepared without iron substitution, Ni—B, presents a pure beta phase with an interlayer distance of 4.7 Å related to the d001 reflection. The NiFe-LDH samples show low crystallinity with broad and asymmetric reflections which are characteristic of a turbostratic structure often observed in the alpha phase. NiFe15 (α-Ni₁₋ₓFeₓ(OH)₂ with x=15) and NiFe20 (α-Ni₁₋ₓFeₓ(OH)₂ with x=20) diffractograms indeed reveal an α-Ni(OH)₂ with a rhombohedral structure (space group R3m). The diffractograms can be indexed on a hexagonal cell (Table 1; see below) where the c-lattice parameter, reflection (003), suggests an interlayer distance (d003) of 8.64 Å for the NiFe15 and 8.25 Å for NiFe20. The Ni—Ni distance, represented by the a-lattice parameter of the hexagonal cell, is 3.05 Å for NiFe15 and 3.00 Å for NiFe20. This variation is caused by the presence of the trivalent cation substituted for Nickel. The ionic radius of Fe³⁺ being smaller than Ni²⁺ radius (ri=0.64 Å and ri=0.70 Å respectively), the Ni—Ni distance decreases with the iron content.

The material NiFe7 (α-Ni₁₋ₓFeₓ(OH)₂ with x=7) shows a peculiar X-ray diffractogram. Like in the α-phase, the two reflections (003) and (006), that represent C_{Hex/3} and C_{Hex/6}, which are distances in the crystal axis in the C-axis direction, are observed below 2θ=30°. However, unlike for NiFe15 and NiFe20, their positions are not submultiples of one another (6.88 Å and 4.39 Å instead of 8.25 Å and 4.15 Å for material NiFe20) meaning that they cannot be indexed as the (003) and (006) reflections of an α-phase. Therefore, we will refer to these reflections as (003*) and (006*). It is typical of an interstratified structure where α and β-Ni(OH)₂ domains coexist within a single crystallite. In the present case an Fe concentration ≥(about) 10% (i.e., x=10) may provide a pure α-phase. In addition to these pseudo (003*) and (006*) reflections, the diffractogram of NiFe7 presents another particularity with an additional reflection at low angle (2θ=6.85°, d=15 Å) which could be attributed to an extra periodicity E.P.

Upon ageing in 6 M KOH, the various doped nickel hydroxides show sharper reflections suggesting an increased degree of crystallinity with bigger crystal on average (FIG. 2). The crystal sizes before and after ageing are displayed in Table 1. Only material NiFe20 shows a pure α phase after 1 month of ageing although the interlayer distance experienced a decrease from 8.25 to 7.70 Å. This may be due to an exchange of SO₄²⁻ by CO₃²⁻ upon ageing in KOH explained by the stronger affinity of carbonate with the LDH layers than other anions.

The diffractogram of aged NiFe7 still shows an interstratified behavior with a (003*) reflection now shifted to higher 2θ angle (d=5.58 Å instead of 6.88 Å before ageing). This can be interpreted as an increase of the β-phase proportion within the interstratified structure. The material NiFe15, which was showing pure α phase before ageing also, shows an interstratified structure now, with the shift of the (003) reflection to higher 2θ angle (6.07 Å instead of 8.64 Å before ageing). The diffractogram appears indeed quite similar to that of NiFe7 before ageing.

To conclude, with an iron concentration of about ≤15 at. %, the amount of intercalated anions balancing the excess of Fe³⁺ positive charge may not be sufficient to uniformly fill the interlayer slab, leading to a segregation effect responsible of the interstratified material formation.

Hence, in embodiments, the one or more metals may comprise at least 15 at. % iron, such as at least 16 at. % iron, especially at least 17 at. % iron, such as at least 18 at. % iron, especially at least 19 at. %, such as at least 20 at. % iron.

TABLE 1
XRD data of the as-prepared and aged α-Ni₁₋ₓFeₓ(OH)₂ samples.

| | | | |
|---|---|---|---|
| | | | Crystal |
| hk1 | d_{obs} (Å) | Cell parameter | size (nm) |

Material (As prepared)

| | | | | |
|---|---|---|---|---|
| NiFe7 | E.P. | 15.0 | Interstratified | 3.5 |
| | (003*) | 6.88 | phase | |
| | (006*) | 4.39 | | |
| NiFe15 | (003) | 8.64 | a = 3.05 Å c = 25.92 Å | 2.2 |
| | (006) | 4.18 | | |
| NiFe20 | (003) | 8.25 | a = 3.00 Å c = 24.77 Å | 1.7 |
| | (006) | 4.15 | | |

Material (Aged)

| | | | | |
|---|---|---|---|---|
| NiFe7 | (003*) | 5.58 | Interstratified | / |
| | (006*) | 4.34 | phase | |
| NiFe15 | (003*) | 6.07 | Interstratified | 3.8 |
| | (006*) | 4.13 | phase | |
| NiFe20 | (003) | 7.70 | a = 3.07 Å c = 23.2 Å | 5.7 |
| | (006) | 3.94 | | |

*The reflections of the interstratified sample cannot be indexed to the d003 and d006 distance of the α-Ni(OH)₂.

The amount of water molecules intercalated in the nickel hydroxide may play an important role for the crystal structure and the electrochemical properties. TGA is used to determine the amount of water contained by the samples. The content of adsorbed and intercalated water is estimated at about 18 wt. % for all the doped samples and about 8 wt. % for conventional β-Ni(OH)₂, Ni—B, which only contains adsorbed water. In embodiments, the second cell may comprise 5-15 wt. intercalated water, such as 7-13 wt. intercalated water The amount of nickel in the samples (wt. %) was determined by ICP and used later for the determination of the number of electron exchanged per nickel atom. The amount of nickel in the samples (wt. %) as well as the Fe/(Ni+Fe) molar ratio determined by ICP are displayed in Table 2. The ICP results confirms the iron doping of the samples at 7, 13 and 18% which is close to the expected values (7, 15, 20%). Hence, the term “NiFe15” may herein especially refer to a second electrode comprising one or more metals, wherein the one or more metals comprise 13 at. % iron, and the term “NiFe20 may herein especially refer to a second electrode comprising one or more metals, wherein the one or more metals comprise 18 at. % iron.

TABLE 2
Chemical composition of the iron-doped
samples determined from ICP analyses.

| Sample | Ni (% wt) | Fe (% wt) | Fe/(Ni + Fe) (%) |
|---|---|---|---|
| Ni—B | 56.5 | 0.0 | 0.00 |
| NiFe7 | 37.0 | 2.6 | 6.9 |
| NiFe15 | 34.0 | 4.9 | 13.1 |
| NiFe20 | 33.3 | 7.0 | 18.1 |

Material cost—Considering the targeted application (GSESS), the electrochemical study focuses on characterizing the performances of the material related to the material cost, its high-rate performances, the energy efficiency and the durability.

The parameter considered in this study to characterize the capacity of the material is the number of electrons exchanged per atom of nickel (NEE) rather than the specific capacity (milliampere-hour per gram of compound). Although the latter is conventionally used in the battery literature, as it is related to energy density, in the stationary storage considered here, the Ni content and therefore the materials cost may be of relatively higher importance.

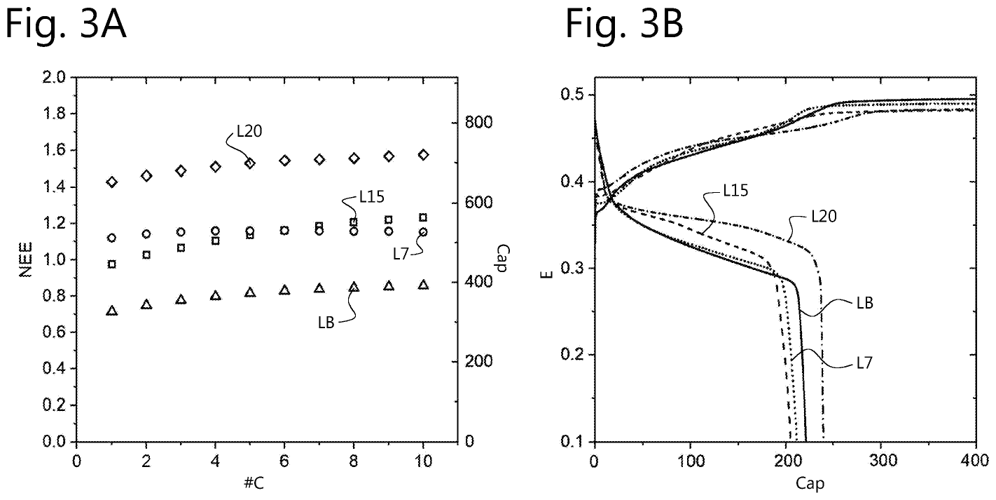

FIG. 3A schematically depicts the evolution of the NEE per Ni atom through the 10 activation cycles (#C) at 0.2C performed on NiFe20 (L20), NiFe15 (L15), NiFe7 (L7), compared to β-Ni(OH)₂ Ni—B (LB). the right axis indicates capacity per gram of Ni in the compound (Cap). FIG. 3B schematically depicts potential E (in V/Hg/HgO, i.e., V versus Hg/HgO reference electrode) for the charge and discharge curves as function of the specific capacity (Cap; in mAh/g of compound) for the 10th activation cycle (#C=10) with C-rate=0.2C, specifically for NiFe20 (L20), NiFe15 (L15), NiFe7 (L7), compared to β-Ni(OH)₂ Ni—B (LB).

FIG. 3A shows the evolution of the capacity along the 10 activation cycles at 0.2C for the three iron-doped samples compared to the pure β-Ni(OH)₂. As expected all the NiFe-LDH materials allow a higher number of electrons exchanged per nickel atom (between 1.15 and 1.57 e−/Ni) than Ni—B that shows 0.86 e−/Ni. From the doped samples, the NiFe20 material shows much better performance than NiFe7 and NiFe15 which reach 1.15 and 1.23 e−/Ni respectively at the end of the activation. The electrochemical performances of the LDH materials can be correlated to their crystal structure. The interstratification of alpha and beta phase layers in the crystal structure of samples NiFe7 and NiFe15 explains the lower capacity reached by these materials. Indeed, only the alpha phase contains tetravalent nickel atoms allowing a higher number of electrons exchanged (NEE). In the interstratified material the average oxidation state of nickel is then decreased by the presence of the beta phase layers. This interstratified structure is already observed before ageing for NiFe7. In the case of NiFe15, the transformation might occur during the preparation steps preceding the activation cycles (soaking of the electrodes and 1st long cycle) as well as during the cycling. The material NiFe20, which was still showing a pure alpha phase after ageing in KOH, gives also the best results with 1.57 e−/Ni. This may constitute an increase by a factor of 1.8 per Ni atom compared to the conventional β-Ni(OH)₂. The amount of nickel in the hydroxide material, and therefore the cost, is then almost halved for a similar capacity.

The analysis of the different materials (dis)charge curves, shown in FIG. 3B, brings more insight to the cycling process. The shape of the charge and discharge curves, for example, reveals the composition of the material. The NiFe15 (dis)charge curves confirm the presence of two different phases (alpha and beta) highlighted by two plateaus visible in charge and discharge around the 100 mAh/g position. This effect is less visible for NiFe7 suggesting that the transformation from alpha to beta is almost complete for this sample.

The charge and discharge potentials appear to be significantly influenced by the iron doping; a gradual increase of the potentials with the iron concentration in the material is observed. The half-discharge potential (Vd_{1/2} vs Hg/HgO) of the different samples increases in this order:

$${Vd}_{\frac{1}{2}} ( NiB ) = 0.32 < {Vd}_{\frac{1}{2}} ( NiFe 7 ) = 0.327 < {V}_{\frac{d 1}{2}} ( NiFe 15 ) = 0.346 < {Vd}_{\frac{1}{2}} ( NiFe 20 ) = 0.355 V / Hg / HgO$$

The same tendency may be noticed for the charge curve as revealed by the half charge potentials of the different samples:

$${Vc}_{\frac{1}{2}} ( NiB ) = 0.435 < {Vc}_{\frac{1}{2}} ( NiFe 7 ) = 0.435 < {Vc}_{\frac{1}{2}} ( NiFe 15 ) = 0.439 < {Vc}_{\frac{1}{2}} ( NiFe 20 ) = 0.446 V / Hg / Hgo$$

The equilibrium potentials at half discharge, OCP(½), have been determined by GITT measurements. The equilibrium potential of the Ni(OH)₂/NiOOH redox couple may show a hysteresis behavior, with the equilibrium potential versus SOC (state of charge) being higher when measured during the charge than during the discharge. This hysteresis behavior could be related to a structural change induced by the intercalation (during discharge) and removal (during charge) of the proton in the Ni(OH)₂ structure causing a lattice expansion and contraction. Thus, two equilibrium potentials are determined from the GITT measurement: OCPc(½) (this is the open circuit potential halfway during charge) and OCPd(½) (this is the open circuit potential halfway during discharge) obtained at SOC=0.5 during the charge and discharge part of the Galvanostatic Intermittent Titration Technique (GITT) curve respectively. The OCP values reveal that there may indeed be an increase of the equilibrium potential with the iron concentration in the Ni(OH)₂ reflecting a higher oxidation state. Nevertheless, the difference in equilibrium potentials OCPc(½)-OCPd(½) is similar for all the samples (about 0.055 V), which confirms that the kinetic charge rate dependent overpotentials may decrease with the iron doping, which may indicate a superior charge transport within the NiFe-LDH samples.

Concerning the electrolysis, the overpotential for OER is visible beyond 300 mAh/g charge inserted in FIG. 3B. The potential may be also impacted by the catalytic behavior of the iron doping and may decrease with the concentration of doping:

E_{OER}(NiB)=0.494>E_{OER}(NiFe7)=0.490>E_{OER}(NiFe15)=0.483>E_{OER}(NiFe20)=0.483 V/Hg/HgO

Sample Ni—B appears to offer more capacity than NiFe7 and NiFe15 when considering the specific capacity in milliamp-hour per gram of compound, while the estimation in NEE/Ni presented earlier gives a different tendency. This is explained by the higher Ni content per gram of compound in Ni—B material which does not contain Fe doping and has no water intercalated, which compensates for the lower NEE per Ni. However, for the sample NiFe20 both a higher specific capacity and a much higher capacity per Ni amount than the β-Ni(OH)₂ are reached. This indicates that despite the reduced Ni amount in the compound and the enhanced OER leading to a lower Faradaic efficiency of the sample, the high number of electrons exchanged by NiFe20 still enables the battery gravimetric energy density to be increased as well.

High-rate performances and energy loss—To be suitable for a grid-stabilization application, an energy storage device may need the capability to charge and discharge at sufficiently high rates. Typically, electricity storage systems may be designed to reach 4 hours of storage duration. Further, renewable solar and wind based energy may also often follow a four hours periodic diurnal behavior. Thus, an advantageous and realistic use of the energy apparatus on a daily base would consist in applying a charge rate of 1C to fully charge the battery in 1 hour for short-term storage (to provide electricity at night) and producing hydrogen for the next 3 hours for long term storage. Charge rates of 1C may therefore be important to target. However, generally, nickel hydroxide may be known to be a poor electronic conductor. If the charge rate is too high, the formation of Ni(OH)₂ during discharge might form insulated layers that interfere with a complete discharge of NiOOH, decreasing the active material utilization. Hence, the impact of the charging rate on the materials capacity has been evaluated by increasing the charge rate, C-rate, from 0.1C to 4C considering a theoretical specific capacity of 490 mAh/g and the total mass of the sample (doping and water included). Therefore, 0.1C corresponds to 49 mA/g (˜0.1 mA/cm2) and 4C to almost 2 A/g (˜4 mA/cm2).

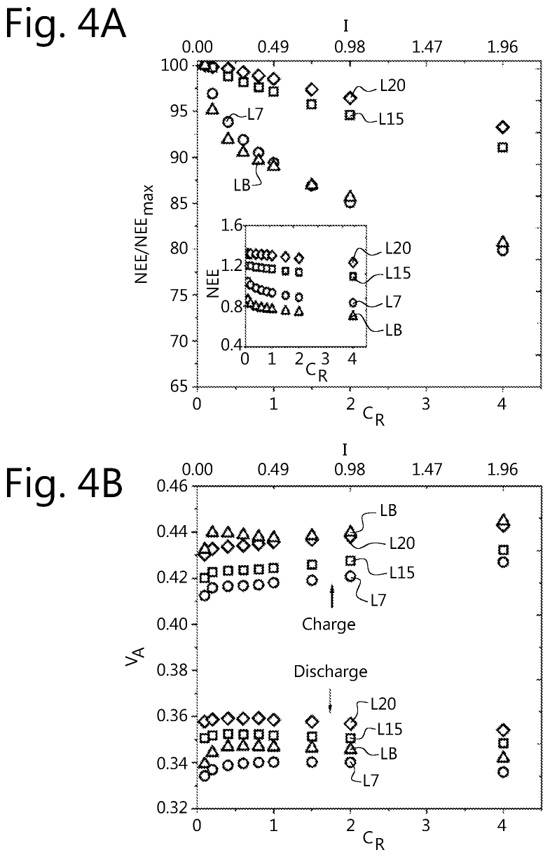

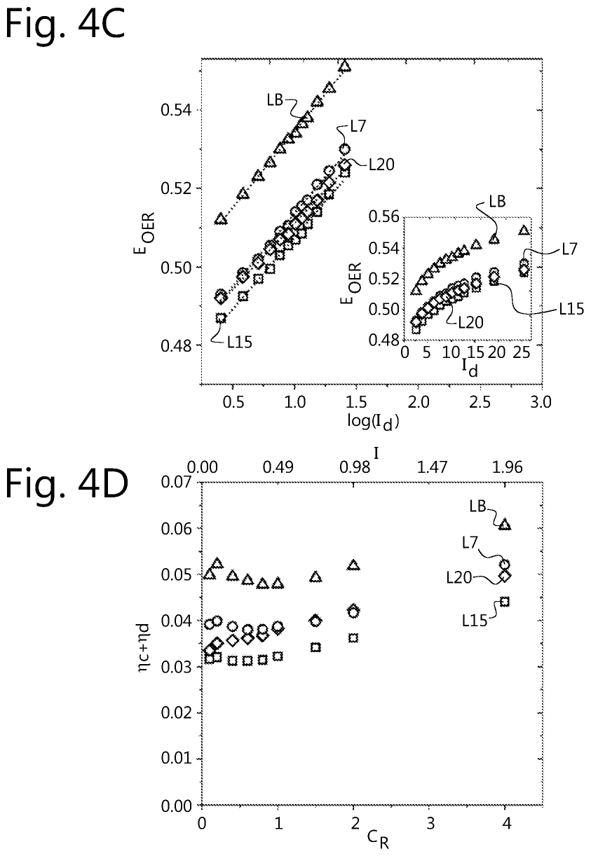

FIG. 4A-D schematically depict high rate performances of the β-Ni(OH)₂ and LDH-Fe—Ni(OH)₂ materials. Specifically, FIG. 4A depicts evolution of the discharge capacity NEE/NEEₘₐₓ (in %) with the C-rate C_{R} represented as ratio of the discharge capacity to the discharge capacity at a C-rate of 0.1C and, in the inset, represented as NEE with the C_{R}. FIG. 4B depicts average voltage V_{A} (in V/Hg/HgO) of the (dis)charge curve for different C-rates C_{R}. FIG. 4C depicts iR corrected OER Tafel plots with evolution of E_{OER} (in V/Hg/HgO) against the log of the current density I_{d} (in log(mA/cm₂), and, in the inset, evolution of E_{OER} (in V/Hg/HgO) with the current density I_{d} (mA/cm₂). FIG. 4D depicts the sum of the kinetic overpotentials ηc+ηd (in V) for different C-rates C_{R}. FIG. 4A,B,D further depict the corresponding current I (in A/g). For each of FIG. 4A-D, reference L7 corresponds to NiFe7, reference L15 corresponds to NiFe15, reference L20 corresponds to NiFe20, and reference LB corresponds to the nickel hydroxide material prepared without iron substitution.

The loss of discharged capacity induced by the current increase is represented in FIG. 4A with the NEE normalized by the value of NEE at 0.1C versus the C-rate. They reveal that the iron doping has a significant impact on the material response to a current increase. Indeed, the discharge capacity reduction induced by the current increase is less for the doped samples and is gradually reduced with the increase of Fe concentration in the material. While the Ni—B material loses 19% of its discharged capacity with a C-rate increase from 0.1 to 4C, only 7% is lost by NiFe20. This can be explained by the better ionic conduction of the protons through the material allowed by the high interlayer distance and water content of the alpha phase, but also to an improvement of the electronic conductivity induced by the iron doping.

The energy loss related to the use of a nickel electrode within a hybrid battery electrolyser device can be decomposed into the battery losses, related to the nickel electrode (dis)charge irreversibility, and the OER loss.

The battery losses can be expressed as follows:

Loss_{bat}(Ni)=(V̅c(Ni)−V̅d(Ni))·Cd Eq.1

Thus, the difference between the average potential of the charge and discharge process \dot{V}c(Ni) and V̅d (Ni) respectively may be an interesting criterion to characterize the energy loss. FIG. 4B shows the impact of the C-rate on V̅c (Ni) and V̅d (Ni).

The difference between charge and discharge potentials influences the battery contribution to the energy efficiency, which is estimated in the following. Ni—B shows the highest V̅c(Ni) for all C-rates and the second lowest V̅d(Ni), which results then in higher energy loss than the NiFe-LDH samples. The energy efficiency loss L_{bat} (Ni) related to the nickel electrode (dis)charge processes (calculated according to Eq. 1 with C_{C}=2C_{d}) corresponds to 2.9% for Ni—B and 2.3% for NiFe20 at 0.1C, when assuming a Ni/Fe full cell charging with an Vc of 1.6 V. For all C-rates the use of NiFe20 instead of Ni—B leads to a reduction of the energy loss of −0.4 to −0.7%. this represents a reduction of 12 to 24% compared to the Ni—B loss.

$${L}_{bat} ( Ni ) = \frac{{Loss}_{bat} ( Ni )}{{Energy}_{inserted}} = \frac{( \overline{V} c ( Ni ) - \overline{V} d ( Ni ) ) . Cd}{\overline{V} c . {C}_{c}} \qquad Eq . 2$$

With C_{d} the discharge capacity, C_{c}=2Cd is the chosen charge inserted (so half of the charge converted to H₂), and Vc the average voltage of the full cell charge estimated at 1.6 V.

For both NiFe20 and Ni—B, Loss_{bat}(Ni) at 4C are slightly higher than at 1C. Considering a Ni/Fe full cell charging with a V̅c of 1.6 V, this corresponds to an increase of the energy efficiency loss L_{bat}(Ni) from of 2.3% to 2.8% for NiFe20 and from 2.9 to 3.3% for Ni—B, according to Eq. 2.

Remarkably, the V̅c(Ni)−V̅d(Ni) difference may be composed of overpotentials related to kinetic effects but also of overpotentials related to the hysteretic effect of the equilibrium potentials. Thus, for a better insight into the kinetic and hysteresis contributions to the energy loss the sum of the kinetic overpotentials ηc+ηd is determined via Eq. 3:

η_{c}(Ni)+η_{d}(Ni)=((V̅c(Ni)−V̅d(Ni))−(E_{c}(Ni)−E_{d}(Ni)) Eq. 3

With η_{c}(Ni)+η_{d}(Ni) the sum of overpotentials averaged over the charge and discharge process. E_{c}(Ni),E_{d}(Ni) the equilibrium potentials averaged over the charge and the discharge of the samples and determined by GITT.

The sum of the overpotentials η_{c}(Ni)+η_{d}(Ni) is represented in FIG. 4D as a function of the C-rate. Thus, for all C-rates the overpotentials are higher for the β-Ni(OH)₂ than for the doped samples. Thus, the kinetic energy loss L_{kinetic} (Ni) for material Ni—B and NiFe20 at 4C represents 1.9% and 1.5% of energy efficiency loss respectively for a full cell charging at V̅c=1.6 V and C_{c}=2C_{d} according to Eq. 4. This decrease of the kinetic overpotential induced by the doping can be explained by a better ionic and electronic pathway as explained earlier and will allow a reduction of the energy loss.

$${L}_{kinetic} ( Ni ) = \frac{( {η}_{c} ( Ni ) + {η}_{d} ( Ni ) ) \times {C}_{d}}{\overline{V} c . {C}_{c}} \qquad Eq . 4$$

For the same charge rate, the hysteresis contribution to the energy efficiency losses corresponds to 1.4% and 1.2% for Ni—B and NiFe20 respectively according to Eq. 5.

$${L}_{hysteresis} ( Ni ) = \frac{( {E}_{c} ( Ni ) - {E}_{d} ( Ni ) ) \times {C}_{d}}{\overline{V} c . {C}_{c}} \qquad Eq . 5$$

Unlike the kinetic loss, the hysteresis loss appears intrinsic to the nickel hydroxide material structural changes during (dis)charge and may therefore be unavoidable. It is also worth noticing that at low C-rate (0.1C) this hysteresis loss is higher than the kinetic loss. For Ni—B it represents an energy efficiency loss of 1.6% while the kinetic loss is 1.4%. The same tendency is observed for the NiFe-LDH samples.

For a conventional NiFe battery function, a high OER potential may be necessary to have a good energy efficiency because it implies a higher faradaic efficiency of the cycling process. In contrast, for the hybrid battery-electrolyser function proposed here, the faradaic efficiency is not affected by the water splitting reaction because the hydrogen and oxygen are useful products. In this case, a decrease of the OER overpotential may even be desirable to allow an improvement of the energy efficiency. The catalytic activity of the nickel hydroxide materials towards OER is characterized by chronopotentiometry with current densities ranging from 0.6 to 25 mA/cm2. The results are displayed in Tafel plots in FIG. 4C and confirm that the doped nickel hydroxides outperform the pure nickel hydroxide in activity and kinetics. Indeed, both the overpotentials and the Tafel slope are lower for NiFe-LDH materials. Material NiFe20 shows a Tafel slope of 34 mV/decade and an overpotential of 205 mV at 10 mA/cm2 while the slope is of 39 mV/decade for Ni—B and the overpotential at 10 mA/cm2 of 230 mV. Due to these excellent catalytic properties the NiFe-LDH can be used for efficient water splitting once the Ni/Fe hybrid battery is fully charged.

The energy efficiency loss related to the OER overpotential can be estimated from the difference between the OER plateau of the different samples charge curves and the thermoneutral potential for OER:

$${L}_{el} ( OER ) = \frac{( {E}_{OER} - {E}_{TN} ( OER ) ) . ( {C}_{c} - {C}_{d} )}{\overline{V} c . {C}_{c}} \qquad Eq 6$$

With E_{TN}(OER), the thermoneutral potential of OER, E_{OER}, the potential of the OER plateau.

As shown in FIG. 4C, E_{OER} is lower than E_{TN}(OER) for all samples at all C-rates applied. This can be explained by external heat coming from the environment. This implies, then, negative energy efficiency losses, Lₑₗ(OER), when compared to the thermoneutral potential for water oxidation. For a full cell charging with V c=1.6 V at 4C, the OER energy efficiency losses are estimated at −3.2% for NiFe20 instead of −2.5% for Ni—B inducing a gain in energy efficiency of +0.7% for the doped sample. Combined with the gain in battery energy efficiency, the use of NiFe20 constitutes an increase in total energy efficiency of +1.1 to +1.4%; since the typical full cell efficiency may be 80-90%, this may constitute a reduction of the overall full cell losses by 7-14%.

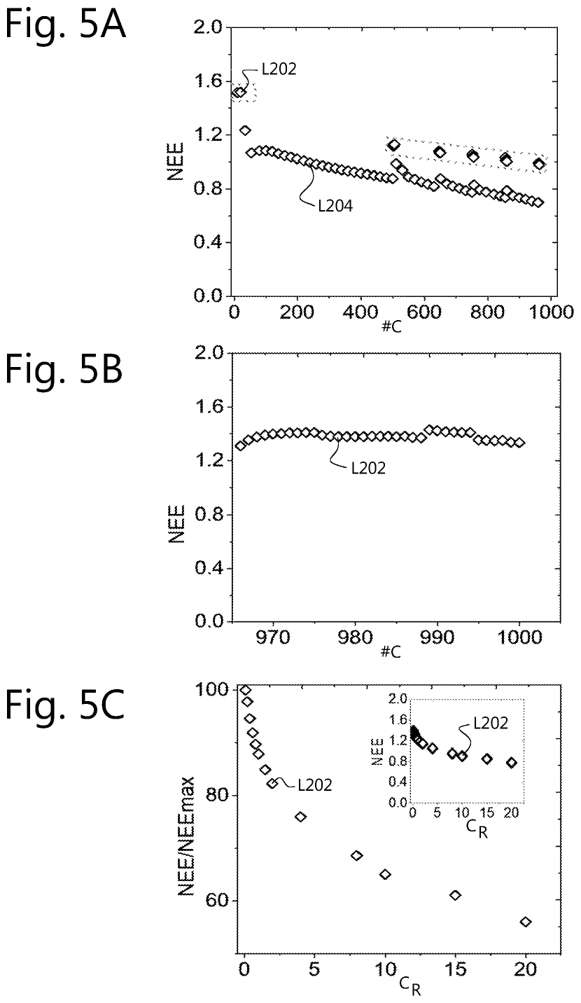

Stability—Sample NiFe20, which gives the best capacity performance of NiFe7, NiFe15 and NiFe20, has been exposed to a life cycle experiment to characterize its stability over the cycling. After the activation and C-rate experiments the electrode has performed 960 cycles at 4C charge, overcharge, and discharge. Mid-way in the life cycle experiments, 6 reactivation cycles at 0.2C were performed every 100 cycles. Finally, at the end of the 960 cycles the electrode was re-pressed to its initial thickness to reconnect the material with the current collector, and the electrode was cycled again at 0.2C. In total the electrode performed 1000 cycles. The whole history of the electrode is represented as NEE in FIG. 5.

A constant decrease of the capacity is observable along the 960 cycles in FIG. 5A. The reactivation cycles performed during the second step of the experiment highlight that it is possible to regain some extra capacity by (dis-)charging the material more slowly. This suggests that some part of the material cannot be reached at such a high (dis-)charge rate due to a weakening of the electronic conductivity path within the electrode. However, the capacity reached during the reactivation cycles also shows a clear decrease over time. In order to determine if the decrease of the capacity is due to the ageing of the material or to a loss of electronic contact, the electrode is re-pressed and reactivated at 0.2C (FIG. 5B). This results in a net increase of the capacity with a NEE going up to 1.41 e−/Ni. Hence, it can be concluded that the NiFe20 material itself is able to withstand a large number of cycles. After 1000 cycles its capacity corresponds to 90% of the capacity obtained after the first 10 activation cycles (NEE=1.57 FIG. 3). On top of that, even after 1000 cycles, the sample NiFe20 still shows a good high rate performance (FIG. 5C). It is able to withstand a C-rate as high as 20C for both charge and discharge, still giving an excellent high number of electrons exchanged (0.8e−/Ni, or in other terms, 46% SOC can be reached in 3 minutes). The stability of the alpha phase within NiFe20 is also confirmed by XRD analysis of the aged electrode, which highlights that the NiFe20 material is still essentially α-Ni(OH)₂ after 1000 cycles. A very small peak corresponding to the β-Ni(OH)₂ is also observable and could explain the small decrease in capacity from 1.57e− to 1.4e− along the 1000 cycles. Nevertheless, the results indicate the high stability of the crystal structure. This is also beneficial for the mechanical stability of the electrode which, when a β-Ni(OH)₂ material is used, may suffer from the swelling of the material.

FIG. 5 schematically depicts experimental observations related to a characterization of NiFe20 stability with a discharge rate of 0.2C (L202) or a discharge rate of 4C (L204). Specifically, FIG. 5A depicts a long-term stability test with NEE versus number of cycles. After the long-term stability test the electrode was repressed and, as depicted in FIG. 5B, the capacity of NiFe20 goes back to 1.4e− exchanged. FIG. 5C schematically depicts high rate performance of the repressed electrode after the long-term stability test in NEE/NEEmax (in %; see above) versus the C-rate C_{R}. The inset in FIG. 5C depicts NEE versus the C-rate C_{R}.

Ni—Fe layered double hydroxides have been investigated for the first time for a hybrid battery-electrolyser application. Thus, battery properties, including storage capacity, rate performance, and cycling stability as well as catalytic OER activity have been characterized. These Fe doped materials appear beneficial for the following aspects:
The stabilization of the alpha/gamma phase couple that allows avoiding the swelling of the electrode and insuring a better mechanical integrity through the charge, discharge and electrolysis processes.
Increased capacity per nickel atom by 83% compared to the conventional beta phase positive electrode material.
Enhanced ionic and electronic conductivity enabling the NiFe-LDH to be (dis-)charged at high rate with lower impact on the capacity (reduced by only 7% at 4C), and at reduced overall energy loss (reduced by 7 to 14%).

With these advancements, the NiFe-LDH can address Ni cost and energy efficiency, as well as stability aspects that are relevant for implementation of the hybrid Ni/Fe battery-electrolyser concept in grid electricity storage and conversion.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

The term “further embodiment” and similar terms may refer to an embodiment comprising the features of the previously discussed embodiment, but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method, respectively.

The term “controlling” and similar terms herein may especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system. The control system and the element may thus at least temporarily, or permanently, functionally be coupled. The element may comprise the control system. In embodiments, the control system and the element may not be physically coupled. Control can be done via wired and/or wireless control. The term “control system” may also refer to a plurality of different control systems, which especially are functionally coupled, and of which e.g. one control system may be a control system and one or more others may be slave control systems.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. An energy apparatus, the energy apparatus comprising one or more functional units, each functional unit comprising:
a first cell, comprising a first cell electrode and one or more first cell openings for a first cell aqueous liquid and for a first cell gas, wherein the first cell electrode comprises an iron-based electrode;
a second cell, comprising a second cell electrode and one or more second cell openings for a second cell aqueous liquid and for a second cell gas, wherein the second cell electrode comprises one or more metals, wherein the one or more metals comprise 60-99.9 at. % nickel, and 0.1-35 at. % iron;
a separator, wherein the first cell and the second cell share the separator, wherein the separator is configured to block transport of one or more of O₂ and H₂ from one cell to another while having permeability for at least one or more of hydroxide ions (OH⁻) monovalent sodium (Na⁺), monovalent lithium (Li⁺) and monovalent potassium (K⁺);
wherein the energy apparatus further comprises:
a charge control unit configured for applying a potential difference between the first cell electrode and the second cell electrode.

2. The energy apparatus according to claim 1, wherein the one or more metals comprise at least 17 at. % iron and at least 70 at. % nickel.

3. The energy apparatus according to claim 1, wherein the energy apparatus has an electrical energy storage functionality and an electrolysis functionality, and wherein during at least part of a charging time the potential difference is more than 1.37 V, and wherein during at least part of a hydrogen generation time the potential difference is selected from the range of 1.37-3.0 V

4. The energy apparatus according to claim 1, wherein the one or more metals may further comprise a metal selected from the group comprising Ti, Cr, Mn, Co, Zn, Sc, Al, Ru, Mo, Zr, Sn, Cu, Al, Y, and La.

5. The energy apparatus according to claim 1, wherein the energy apparatus further comprises an aqueous liquid control system configured to control introduction of one or more of the first cell aqueous liquid and the second cell aqueous liquid into the functional unit.

6. The energy apparatus according to claim 1, wherein the energy apparatus further comprises a storage system configured to store one or more of the first cell gas and the second cell gas external from said functional unit.

7. The energy apparatus according to claim 6, wherein the energy apparatus further comprises a pressure system configured to control one or more of (a) the pressure of the first cell gas in the functional unit, (b) the pressure of the first cell gas in the storage system, (c) the pressure of the second cell gas in the functional unit, and (d) the pressure of the second cell gas in the storage system.

8. The energy apparatus according to claim 1, wherein the energy apparatus further comprises a first electrical connection in electrical connection with the first cell electrode, a second electrical connection in electrical connection with the second cell electrode, a first connector unit for functionally coupling to a receiver to be electrically powered and to the electrical connection, and a second connector unit for functionally connecting a device to be provided with one or more of the first cell gas and the second cell gas with the storage system.

9. The energy apparatus according to claim 1, wherein the energy apparatus comprises two or more first cell electrodes and (b) two or more second cell electrodes, wherein the energy apparatus further comprises an electrical element configured for applying one or more of (a) a first potential difference between the two or more first cell electrodes and (b) a second potential difference between the two or more second cell electrodes.

10. The energy apparatus according to claim 9, wherein the electrical element is configured for applying a potential difference between a first subset of the two or more first cell electrodes and a second subset of the two or more first cell electrodes, wherein the first cell electrodes of the first subset comprise iron-based electrodes, and wherein the first cell electrodes of the second subset comprise either iron-based electrodes or hydrogen gas generating electrodes.

11. An energy system comprising the energy apparatus according to claim 1 and an external power source.

12. A method of storing electrical energy and one or more of hydrogen (H₂) and oxygen (O₂) with the energy apparatus according to claim 6, the method comprising: providing the first cell aqueous liquid, the second cell aqueous liquid, and electrical power from an external power source to the functional unit thereby providing an electrically charged functional unit and one or more of hydrogen (H₂) and oxygen (O₂) stored in the storage system.

13. The method according to claim 12, wherein during at least part of a charging time the functional unit is charged at a potential difference between the first cell electrode and the second cell electrode of more than 1.37 V.

14. Use of the energy apparatus according to claim 1 for providing one or more of electrical power, hydrogen (H₂) and oxygen (O₂) to a receiver.

15. An electrode, wherein the electrode comprises an electrode material, wherein the electrode material comprises one or more metals, wherein the one or more metals comprise 17-23 at. % iron, and at least 70 at. % nickel, wherein the electrode comprises α-Ni(OH)₂ with a rhombohedral structure, and wherein the electrode material comprises ≥5 wt. % intercalated water, wherein the electrode comprises 0.5-10 vol. % of a conductive additive selected from the group comprising stainless steel fiber, nickel fiber, carbon fiber, atomized nickel, and stainless steel particles.

16. The electrode according to claim 15, wherein the electrode comprises intercalated anions comprising one or more of SO₄²⁻, OH⁻, Cl⁻, and CO₃²⁻.

17. Use of an electrode in a integrated battery and electrolysis apparatus, wherein the electrode comprises an electrode material, wherein the electrode material comprises one or more metals, wherein the one or more metals comprise 17-23 at. % iron, and at least 70 at. % nickel, wherein the electrode comprises α-Ni(OH)₂ with a rhombohedral structure, and wherein the electrode material comprises ≥5 wt. % intercalated water.

18. A method for assembling an energy apparatus according to claim 1, wherein the method comprises functionally coupling the functional unit and the charge control unit.

19. Use of the energy apparatus according to the energy system according to claim 11, for providing one or more of electrical power, hydrogen (H₂) and oxygen (O₂) to a receiver.
